(19) United States
(12) Patent Application Publication
(10) Pub. No.: US 2026/0367884 A1
(43) Pub. Date: Nov. 19, 2026

(54) AUTOMATED CODE EVALUATION AND ENHANCEMENT USING LARGE LANGUAGE MODELS

(71) Applicant: International Business Machines Corporation, Armonk, NY (US)

(72) Inventors: Brad Lee BLANCETT, Raleigh, NC (US); Pooja AGGARWAL, Bengaluru (IN); Oishik CHATTERJEE, Kolkata (IN); Ting DAI, Tampa, FL (US); Prateeti MOHAPATRA, Bangalore (IN); Arthur DE MAGALHAES, Markham (CA); Chad HOLLIDAY, Holly Springs, NC (US); Steven Paul BARBIERI, Research Triangle Park, NC (US); Eugen POSTEA, Ontario (CA)

(21) Appl. No.: 19/212,644

(22) Filed: May 19, 2025

(51) Int. Cl. G06F 8/35

(52) U.S. Cl. CPC G06F 8/35

(57) ABSTRACT

An indication of an action to be performed by generated code is received, wherein the generated code is generated by a large language model (LLM). A functionality of the generated code is determined using a machine learning component. A functional correctness of the generated code is determined using the machine learning component by performing a semantic validation operation without executing the generated code or comparing the generated code to a ground truth reference. A reasoning explanation associated with the functional correctness of the generated code is extracted. Feedback is obtained based on the reasoning explanation. A refined prompt is generated by refining a prompt using the generated feedback to improve subsequent code generation by the LLM.

### STATEMENT REGARDING PRIOR DISCLOSURES BY THE INVENTOR OR A JOINT INVENTOR

This application relates to a prior disclosure made available to the public on Sep. 12, 2024, entitled SCRIPTSMITH: A UNIFIED LLM FRAMEWORK FOR ENHANCING IT OPERATIONS VIA AUTOMATED BASH SCRIPT GENERATION, ASSESSMENT, AND REFINEMENT, at https://arxiv.org/pdf/2409.17166. This application also relates to a prior disclosure made available to the public on Aug. 28, 2024, entitled CODESIFT: AN LLM-BASED REFERENCE-LESS FRAMEWORK FOR AUTOMATIC CODE VALIDATION, at https://arxiv.org/pdf/2408.15630. The contents of the foregoing prior disclosures are hereby incorporated by reference for all purposes.

### BACKGROUND

The present invention relates to code generation, and for example, relates to automated code evaluation and enhancement.

### SUMMARY

In one embodiment, a computer-implemented method is provided. In this embodiment, the method includes receiving an indication of an action to be performed by generated code, wherein the generated code is generated by a large language model (LLM). The method further includes determining, using a machine learning component, a functionality of the generated code. Additionally, the method includes determining, using the machine learning component, a functional correctness of the generated code by performing a semantic validation operation without executing the generated code or comparing the generated code to a ground truth reference. The method also includes extracting a reasoning explanation associated with the functional correctness of the generated code, obtaining feedback based on the reasoning explanation, and generating a refined prompt by refining a prompt using the generated feedback to improve subsequent code generation by the LLM.

In another embodiment, a computer program product is provided. In this embodiment, the computer program product includes one or more computer-readable storage media and program instructions stored on the one or more computer-readable storage media to perform operations. The operations include receiving an indication of an action to be performed by generated code, wherein the generated code is generated by an LLM. The operations further include determining, using a machine learning component, a functionality of the generated code. Additionally, the operations include determining, using the machine learning component, a functional correctness of the generated code by performing a semantic validation operation without executing the generated code or comparing the generated code to a ground truth reference. The operations also include extracting a reasoning explanation associated with the functional correctness of the generated code, obtaining feedback based on the reasoning explanation, and generating a refined prompt by refining a prompt using the generated feedback to improve subsequent code generation by the LLM.

In yet another embodiment, a computer system is provided. In this embodiment, the computer system includes a processor set, one or more computer-readable storage media, and program instructions stored on the one or more computer-readable storage media to cause the processor set to perform operations. The operations include receiving an indication of an action to be performed by generated code, wherein the generated code is generated by an LLM. The operations further include determining, using a machine learning component, a functionality of the generated code. Additionally, the operations include determining, using the machine learning component, a functional correctness of the generated code by performing a semantic validation operation without executing the generated code or comparing the generated code to a ground truth reference. The operations also include extracting a reasoning explanation associated with the functional correctness of the generated code, obtaining feedback based on the reasoning explanation, and generating a refined prompt by refining a prompt using the generated feedback to improve subsequent code generation by the LLM.

### BRIEF DESCRIPTION OF THE DRAWINGS

FIG. 1A is a block diagram of an example computing environment described herein.

FIG. 1B is a data flow diagram of an example associated with a process for automated code evaluation and enhancement implemented by the code manager of FIG. 1A.

FIG. 1C is a data flow diagram of an example of the action processing engine of FIG. 1A.

FIG. 1D is a data flow diagram of another example associated with a process for automated code evaluation and enhancement implemented by the code manager of FIG. 1A.

FIG. 1E is a data flow diagram of an example of the semantic validation engine of FIG. 1A.

FIG. 1F is a data flow diagram of an example of the feedback component of FIG. 1A.

FIGS. 2A-2E are schematic diagrams showing examples of associated with automated code evaluation and enhancement described herein.

FIG. 3 is a diagram of an example computing environment in which systems and/or methods described herein may be implemented.

FIG. 4 is a diagram of example components of one or more devices of FIG. 1A.

FIG. 5 is a flowchart of an example technique associated with automated code evaluation and enhancement described herein.

### DETAILED DESCRIPTION

The following detailed description of example implementations refers to the accompanying drawings. The same reference numbers in different drawings may identify the same or similar elements.

In the realm of software development and system administration, the generation and evaluation of code have become increasingly important tasks. As software systems grow in complexity and scale, there is a need for automated tools that can assist developers and administrators in creating, assessing, and refining code efficiently. Traditional approaches to code generation and evaluation often rely on manual processes or require extensive sets of predefined test cases, which can be time-consuming, error-prone, and limited in their ability to cover diverse scenarios.

Large language models (LLMs) have emerged as powerful tools for generating code based on natural language descriptions. However, the evaluation of LLM-generated code presents technical challenges. Current methods for assessing code correctness typically involve executing the code or comparing it against pre-existing reference solutions. These approaches have inherent limitations, particularly when dealing with non-deterministic tasks, system-dependent operations, or scenarios where ground truth solutions are not readily available. Furthermore, the execution of generated code in isolated environments with proper configurations can be complex and resource-intensive, especially for system administration tasks or operations that interact with specific hardware or network setups.

The lack of efficient, reference-less, and execution-less code evaluation methods hampers the widespread adoption and trust in automated code generation systems. Without reliable means to validate the functional correctness and safety of generated code, developers and system administrators are often forced to manually review and test each output, negating much of the potential time-saving benefits of automated code generation. This problem is particularly noticeable in domains such as system administration and shell scripting, where actions can have impacts on system stability and security, and where the diversity of possible valid implementations makes traditional comparison-based evaluation methods less effective.

Additionally, the current state of automated code generation often lacks a robust feedback mechanism to improve the quality of generated code over time. While LLMs can produce code based on initial prompts, they typically do not incorporate learnings from evaluation results to refine their outputs systematically. This limitation results in a static generation process that may repeatedly produce similar errors or suboptimal solutions, rather than evolving and improving based on past performance and feedback. The absence of such a dynamic improvement loop represents a barrier to achieving truly intelligent and adaptive code generation systems that can meet the evolving needs of software development and system administration tasks.

Implementations of this disclosure address problems such as these by providing a system and method for automated code evaluation and enhancement using LLMs without requiring code execution or comparison to ground truth references. The disclosed approach involves receiving an indication of an action to be performed by generated code, determining the functionality and functional correctness of the generated code using a machine learning component, extracting a reasoning explanation associated with the functional correctness, obtaining feedback based on the reasoning explanation, and generating a refined prompt to improve subsequent code generation.

In some implementations, the system may perform a semantic validation operation to determine the functional correctness of the generated code. This operation may involve generating a textual description of the generated code using the machine learning component and comparing it to a natural language representation of the action. In some implementations, the semantic validation may include determining sets of similarity and difference evidence items based on analyses of the action and the code functionality. The term “evidence items” refers to aspects or characteristics identified during the analysis that support or contradict the functional correctness of the generated code. For example, an evidence item might be a particular code structure that aligns with the intended action, or a discrepancy between the code's output and the expected result.

The system may employ various techniques to rank and evaluate the evidence items. In some implementations, the ranking process may involve performing additional similarity or difference analyses and assigning consistency scores to each item based on the frequency of its appearance across multiple analyses. In some implementations, the ranking may be based on generating sample outputs using the code and comparing them to expected outputs derived from the evidence items. This approach allows for a more nuanced and reliable assessment of the code's correctness without relying on traditional execution-based testing methods.

The feedback generation process in this disclosure may involve identifying syntactic or semantic corrections based on the reasoning explanation. In some implementations, the system may utilize a retrieval-augmented generation (RAG) approach to obtain feedback. The term “RAG prompt” refers to a specially crafted input for the machine learning component that incorporates relevant contextual information to guide the feedback generation process. For instance, a RAG prompt might include details about identified errors in the code and potential solutions, enabling the machine learning component to provide more targeted and effective feedback.

The disclosed system may be configured for handling system administration operations and shell script tasks, which often involve complex, system-dependent actions that are challenging to evaluate using traditional methods. By decomposing actions into atomic sub-actions, the system can determine whether each sub-action is automatable and generate appropriate prompts. This decomposition process allows for a more granular and accurate assessment of the action's completeness and feasibility.

In some implementations, the system may determine that an action is incomplete based on the analysis of its atomic sub-actions. In such cases, the system may be configured to obtain completion information from one or more external systems. This capability enables the system to handle more complex and context-dependent tasks by dynamically gathering necessary information to complete the action specification.

The refined prompt generated by the system serves as a component in improving subsequent code generation. By incorporating feedback and learnings from the evaluation process, the system can iteratively enhance the quality and accuracy of the generated code over time. This dynamic improvement loop represents an advancement over static code generation systems, enabling the LLM to adapt and evolve its code generation capabilities based on past performance and feedback.

In some implementations, the system may incorporate additional features such as multi-modal input processing, allowing it to interpret actions specified through various means such as natural language, flowcharts, or pseudocode. The feedback mechanism could also be extended to include collaborative elements, enabling human experts to provide input alongside the automated system, further enhancing the quality and reliability of the generated code.

In some implementations, the system performs semantic validation of generated code without execution or comparison to ground truth references. Accordingly, an advantage of the semantic validation approach is improved efficiency by eliminating the need for complex execution environments or extensive test case databases. Additionally, an advantage of the semantic validation approach is increased flexibility in evaluating code for diverse tasks and programming languages. Furthermore, an advantage of the semantic validation approach is enhanced security by avoiding potential risks associated with executing untrusted generated code.

In some implementations, the system utilizes a feedback mechanism to refine prompts for improved code generation. Accordingly, an advantage of the feedback mechanism is continuous improvement of code quality over time through iterative refinement. Additionally, an advantage of the feedback mechanism is adaptability to evolving coding standards and best practices by incorporating the latest feedback into prompt refinement. Moreover, an advantage of the feedback mechanism is reduced reliance on manual code review processes by automating the identification and correction of common errors.

In some implementations, the system decomposes complex actions into atomic sub-actions for more granular processing. Accordingly, an advantage of the action decomposition approach is improved handling of complex, multi-step tasks by breaking them down into manageable components. Additionally, an advantage of the action decomposition approach is enhanced ability to identify and exclude non-automatable steps, focusing computational resources on feasible code generation tasks. Furthermore, an advantage of the action decomposition approach is increased accuracy in assessing action completeness and identifying missing information required for successful code generation.

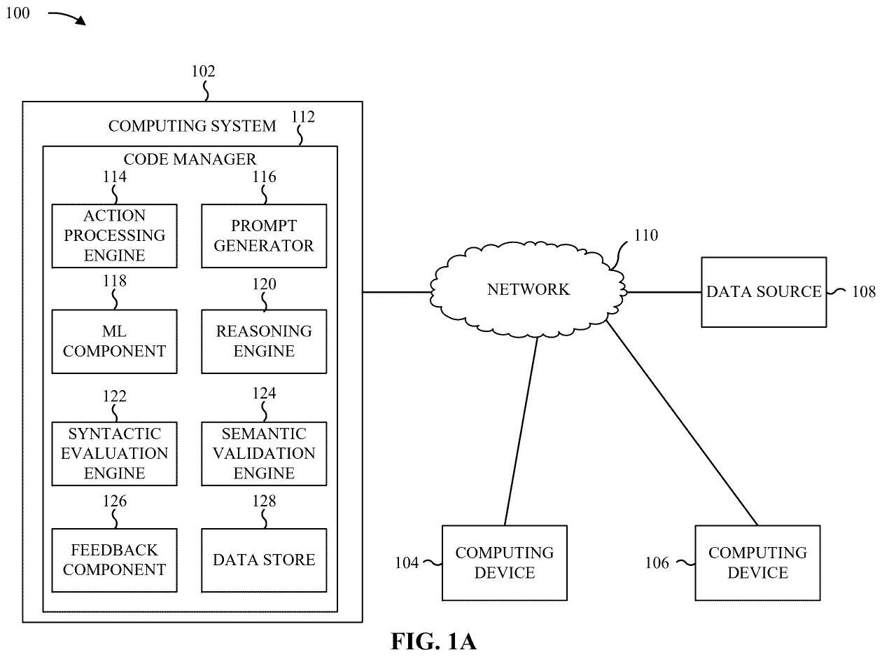

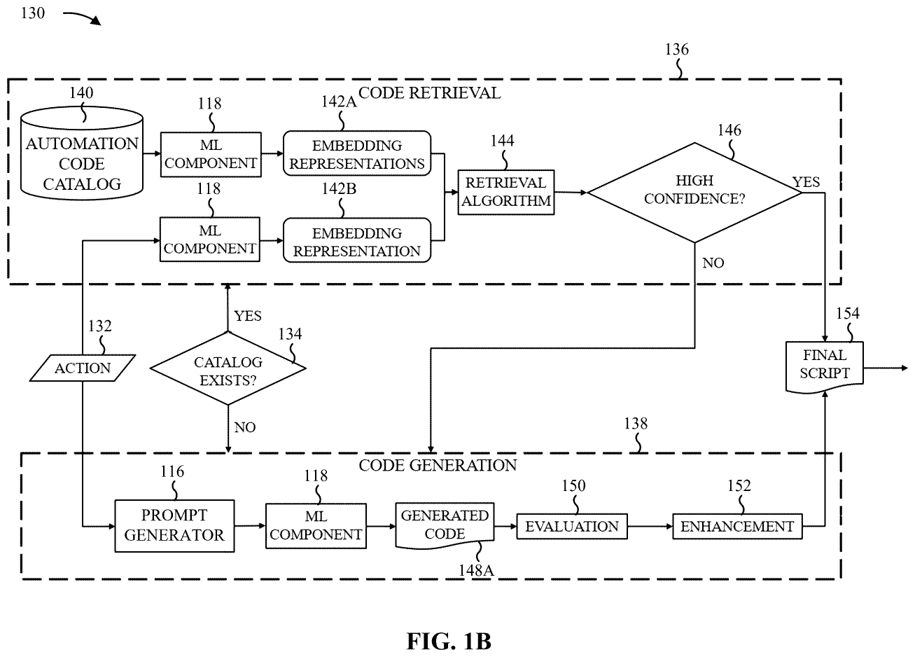

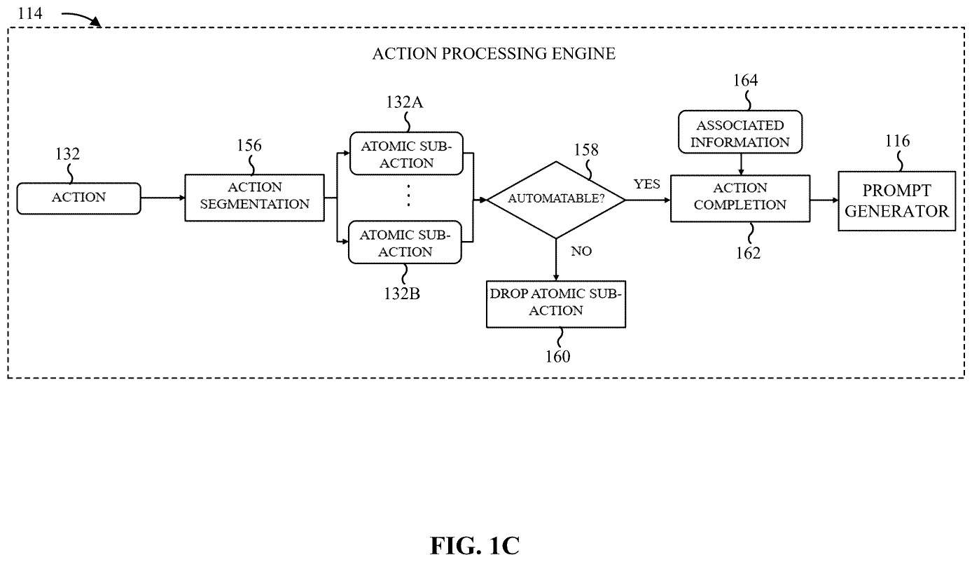

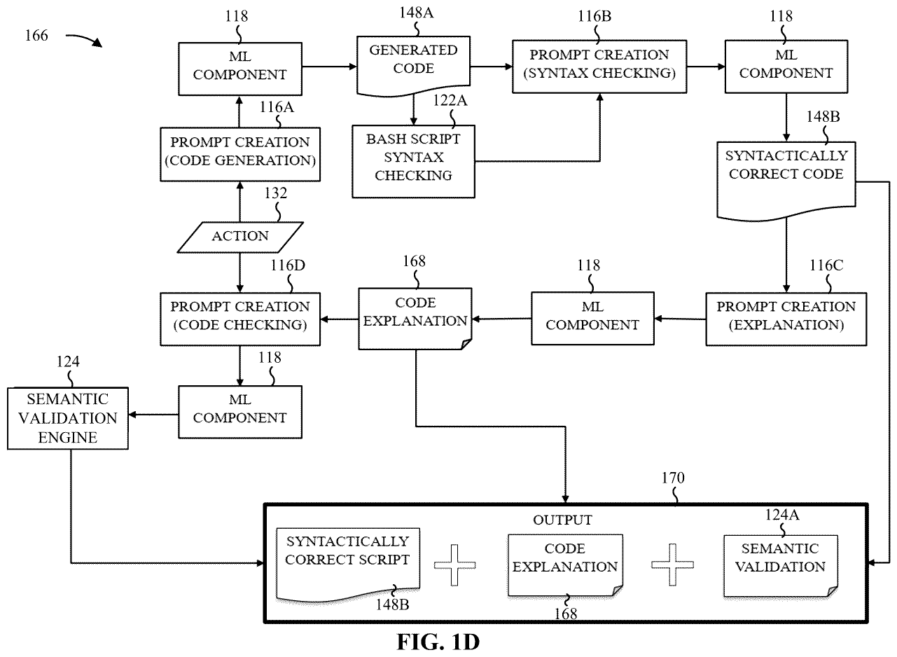

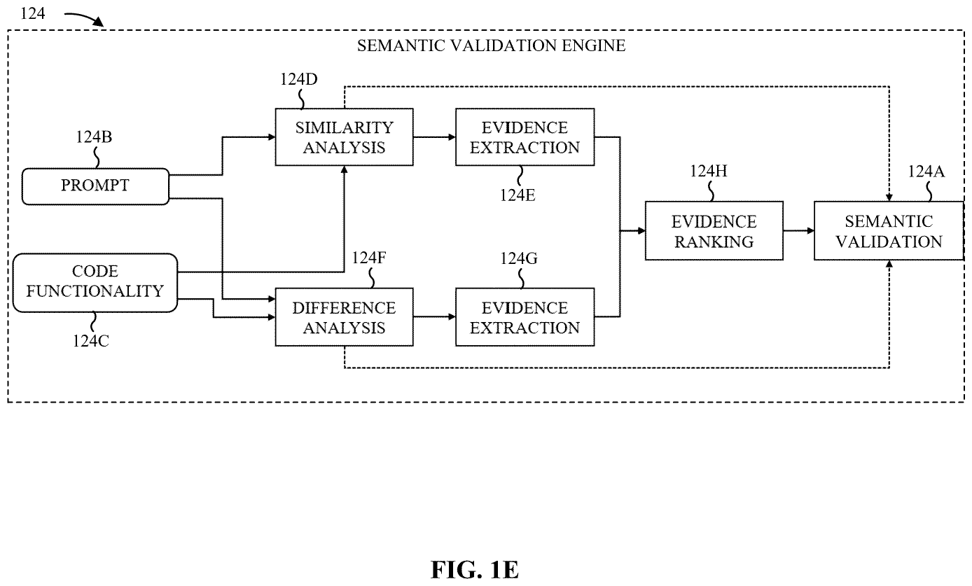

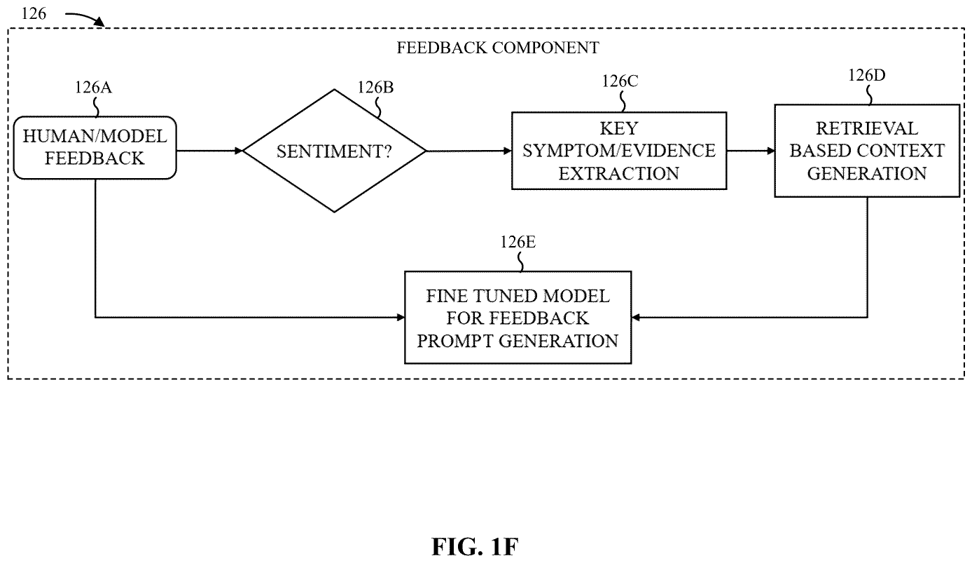

FIG. 1A illustrates a block diagram of an example computing environment 100 for automated code evaluation and enhancement using large language models. As shown, the computing environment 100 includes a computing system 102, computing devices 104 and 106, a data source 108, and a network 110 connecting these components. In some implementations, the computing system 102 may be any suitable computing system or environment such as a cloud, a server system, or individual computers or computing devices. For example, the computing system 102 may include one or more servers or computer systems that are remote from an end user device from which code manager may be accessed. In some implementations, the computing devices 104 and 106 each includes a computing device or a collection of computing devices. For example, the computing devices 104 and 106 each may include a computer, a laptop computer, a desktop computer, or a collection of servers or computer systems (e.g., a server farm). In some implementations, the data source 108 may include a data storage or database. In some implementations, the data source 108 may be part of the computing system 102.

The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

As shown, the computing system 102 includes a code manager 112. The code manager 112 includes an action processing engine 114, a prompt generator 116, a machine learning component 118, a reasoning engine 120, an evaluation engine 122, a semantic validation engine 124, a feedback component 126, and a data store 128. Any of the components 114, 116, 118, 120, 122, 124, 126, or 128 may be implemented using hardware and/or software. In some implementations, any two or more of the action processing engine 114, the prompt generator 116, the machine learning component 118, the reasoning engine 120, the evaluation engine 122, the semantic validation engine 124, the feedback component 126, and the data store 128 may be integrated into the same component (e.g., a single server system or an integrated program).

The action processing engine 114 may be configured to receive and process actions that serve as inputs for code generation tasks. In some implementations, the action processing engine 114 may analyze incoming actions to determine their complexity and structure. This analysis may involve parsing natural language descriptions, identifying key components of the requested action, and categorizing the action based on predefined criteria or learned patterns.

The action processing engine 114 may include functionality to decompose composite actions into atomic sub-actions. This decomposition process may involve breaking down multi-step operations into smaller, more manageable units that can be individually processed and evaluated. In some cases, the action processing engine 114 may utilize natural language processing techniques or rule-based systems to identify logical breakpoints within an action description. The engine may also assess each sub-action to determine if it is automatable, potentially flagging any steps that require human intervention or additional information.

In some implementations, the action processing engine 114 may interface with external systems or databases to gather additional context or information needed to fully understand and process the action. This may include retrieving system-specific details, accessing user preferences, or querying knowledge bases for relevant domain information. The action processing engine 114 may incorporate error handling and validation mechanisms to ensure that processed actions are well-formed and contain all necessary information before being passed to subsequent components in the code generation pipeline.

The prompt generator 116 may be configured to generate prompts for the ML component 118. The prompts may be used for any number of different tasks. The prompt generator 116 may be configured to generate prompts for the ML component 118. The prompts may be used for any number of different tasks. For example, the prompt generator 116 may generate prompts for code generation, syntactic evaluation, reasoning evaluation, feedback gathering, semantic validation, or other tasks. The prompt generator 116 may initiate an instance of the ML component 118 to process the prompt and generate output.

The prompt generator 116 may be configured to create structured inputs for the ML component 118 based on the processed actions received from the action processing engine 114. In some implementations, the prompt generator 116 may utilize templates or schemas to format the action information into a standardized prompt structure that is optimized for the specific large language model being used. The prompt generator 116 may incorporate various contextual elements into the prompts, such as relevant system information, user preferences, or domain-specific knowledge, to provide the ML component 118 with comprehensive inputs for code generation.

In some cases, the prompt generator 116 may implement adaptive prompt generation techniques that evolve based on feedback and performance metrics. The prompt generator 116 may analyze the effectiveness of previously generated prompts by examining the quality and correctness of the resulting code outputs. Using this information, the prompt generator 116 may refine its prompt creation strategies over time, potentially employing machine learning techniques to identify patterns in successful prompts and incorporate those patterns into future prompt generations.

The prompt generator 116 may also include functionality to handle multi-modal inputs and generate corresponding multi-modal prompts. For example, if an action is specified using a combination of natural language, flowcharts, and pseudocode, the prompt generator 116 may be capable of synthesizing these diverse input formats into a cohesive prompt that captures the full intent and complexity of the requested action. This flexibility in input processing and prompt generation may allow the system to accommodate a wide range of user preferences and action specification methods.

The prompt generator 116 may employ a variety of techniques to create effective prompts for the ML component 118. In some implementations, the prompt generator 116 may utilize rule-based prompt generation techniques, which may involve predefined sets of rules and heuristics to construct prompts based on the characteristics of the input action and the desired output. These rules may be designed to capture common patterns and structures in code generation tasks, allowing for consistent and predictable prompt creation.

In some cases, the prompt generator 116 may leverage machine learning techniques to dynamically generate and refine prompts. This approach may involve training models on large datasets of successful code generation examples, enabling the prompt generator to learn optimal prompt structures and content over time. The machine learning-based prompt generation may adapt to different coding styles, programming languages, and task complexities, potentially improving the overall quality and relevance of the generated prompts.

In some cases, the prompt generator 116 may incorporate template-based methods for prompt creation. These templates may serve as pre-defined frameworks or schemas that can be populated with specific details from the input action. The use of templates may help facilitate consistency across different types of code generation tasks while allowing for customization based on the particular requirements of each action. In some implementations, the prompt generator 116 may maintain a library of templates that can be selected and tailored based on factors such as the programming language, task complexity, or specific coding patterns required.

The prompt generator 116 may also combine these different approaches, using a hybrid system that leverages the strengths of rule-based, machine learning, and template-based techniques. This multi-faceted approach may allow the prompt generator to handle a wide range of code generation scenarios, from simple, well-defined tasks to more complex, open-ended programming challenges. By utilizing this diverse set of prompt generation methods, the system may be able to create more nuanced and effective prompts, potentially leading to improved code generation outcomes from the ML component 118.

The ML component 118 may serve as a processing unit for code generation and evaluation tasks within the system. A machine learning (ML) component refers to hardware and/or software capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, LLMs, and/or support vector machines (SVMs), among other examples.

Two common types of problems in ML are classification problems and regression problems. Classification problems, also referred to as categorization problems, aim at classifying items into one of several category values (for example, is this object an apple or an orange). Regression algorithms aim at quantifying some items (for example, by providing a value that is a real number). ML components utilize training data to find correlations among identified features that affect the outcome. For example, ML components utilize features for analyzing the data to generate assessments. A feature is an individual measurable property of a phenomenon being observed. The concept of a feature is related to that of an explanatory variable used in statistical techniques such as linear regression. Choosing informative, discriminating, and independent features is important for effective operation of the ML component in pattern recognition, classification, and regression. Features may be of different types, such as numeric features, strings, and graphs.

ML components utilize the training data to find correlations among the identified features that affect the outcome or assessment. In some example embodiments, the training data includes labeled data, which is known data for one or more identified features and one or more outcomes. With the training data and the identified features, the ML component may be trained. The ML component appraises the value of the features as they correlate to the training data. The result of the training is the trained ML component. When the ML component is used to perform an assessment, new data is provided as an input to the trained ML component, and the ML component generates an assessment as output.

ML techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the ML technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of natural language processing (NLP), ML training software can employ a learning paradigm focused on human preferences to better align pretrained and instruction-tuned generative language models with human values. This process involves the ML training software collecting extensive data, where each data point includes a context, pairs of continuations of the context (generations), and a pairwise human preference indicating the superior generation. Subsequently, the ML training software learns to generate optimal continuations for a given context based on the collected data.

In some cases, the ML training software may employ reinforcement learning (RL), which is a method of training neural networks that may be used, for example, for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

In some implementations, the ML component 118 may be based on an LLM architecture, such as a transformer-based model, that has been fine-tuned on extensive datasets of code and programming-related text. This training may enable the ML component 118 to understand and generate code across various programming languages, frameworks, and paradigms. The ML component 118 may be capable of processing natural language inputs, code snippets, and structured prompts to produce relevant code outputs, explanations, and analyses.

In some aspects, the ML component 118 may incorporate multi-task learning capabilities, allowing it to switch between different code-related tasks such as generation, completion, refactoring, and evaluation. The ML component 118 may utilize context-aware processing techniques to maintain coherence and consistency across multiple interactions within a single coding session. In some implementations, the ML component 118 may employ few-shot or zero-shot learning approaches, enabling it to adapt to novel coding tasks or unfamiliar programming languages with minimal additional training. The ML component 118 may integrate retrieval-augmented generation mechanisms, allowing it to access and incorporate relevant information from external knowledge bases or documentation during the code generation process.

The ML component 118 may include built-in safeguards and ethical considerations to facilitate adherence to best practices, security standards, and legal requirements. In some cases, the ML component 118 may utilize a hierarchical decision-making process to balance multiple objectives such as code efficiency, readability, and maintainability. The ML component 118 may feature self-evaluation capabilities, allowing it to assess the quality and potential limitations of its own outputs. This self-awareness may enable the component to provide confidence scores or alternative suggestions when faced with ambiguous or challenging coding tasks. In some implementations, the ML component 118 may be designed with extensibility in mind, allowing for easy integration of new models, techniques, or domain-specific knowledge as the field of AI-assisted coding continues to evolve.

In some implementations, any of the other components of the code manager 112 may include or utilize the ML component 118. For example, the action processing engine 114, prompt generator 116, reasoning engine 120, syntactic evaluation engine 122, semantic validation engine 124, and feedback component 126 may each incorporate aspects of the ML component 118 to enhance their respective functionalities. This integration may allow these components to leverage the advanced natural language processing and code understanding capabilities of the ML component 118. By utilizing the ML component 118, these other components may adapt and improve their performance over time, potentially leading to more accurate code generation, more effective prompt refinement, and more insightful code evaluation. The flexibility of the ML component 118 may enable it to be tailored to the specific needs of each component, potentially improving the overall efficiency and effectiveness of the code manager 112.

The reasoning engine 120 may be configured to extract reasoning explanations associated with the functional correctness of generated code. In some implementations, the reasoning engine 120 may determine sets of similarity and difference evidence items based on analyses of the action and the code functionality. The reasoning engine 120 may be designed to analyze and interpret the generated code in relation to the original action or task specification. In some implementations, the reasoning engine 120 may employ natural language processing techniques to parse both the action description and the generated code, extracting key concepts, intentions, and logical structures. This analysis may allow the reasoning engine 120 to construct a semantic representation of both the desired outcome and the actual code implementation, facilitating a more nuanced comparison beyond simple syntax matching.

The reasoning engine 120 may utilize various analytical approaches to assess the functional correctness of the generated code. In some cases, the engine may employ symbolic reasoning techniques to logically deduce the effects and outcomes of the code execution without actually running the code. In some implementations, the reasoning engine 120 may incorporate machine learning models trained on large datasets of code-to-functionality mappings, enabling it to predict the likely behavior and output of the generated code. These predictions may then be compared against the expected functionality derived from the original action description, allowing the system to identify potential discrepancies or misalignments between the intended and actual code behavior.

In some implementations, the reasoning engine 120 may generate detailed explanations of its analysis process and findings. These explanations may include step-by-step breakdowns of the code's logical flow, identification of key decision points or potential edge cases, and assessments of how well the code addresses different aspects of the original task. The reasoning engine 120 may also highlight areas where the generated code may deviate from best practices or introduce potential vulnerabilities, providing a comprehensive evaluation that goes beyond simple correctness checks. This contextual feedback may be used by other components of the system, such as the feedback component 126, to guide further refinements and improvements in the code generation process.

The syntactic evaluation engine 122 may be designed to perform comprehensive syntax analysis and correction on generated code. In some implementations, the syntactic evaluation engine 122 may utilize a combination of static analysis techniques and language-specific parsing tools to identify potential syntax errors, style violations, and structural issues within the code. The engine may be configured to handle multiple programming languages and may adapt its evaluation criteria based on the specific language and coding standards associated with each task.

The syntactic evaluation engine 122 may work in conjunction with the reasoning engine 120 to provide context-aware syntax checking. By leveraging the reasoning explanations generated by the reasoning engine 120, the syntactic evaluation engine 122 may be able to distinguish between intentional code structures and genuine syntax errors. This approach may allow the engine to make more informed decisions when suggesting corrections, preserving unique or domain-specific code patterns that might otherwise be flagged as errors by traditional syntax checkers. In some cases, the syntactic evaluation engine 122 may consider the original action description and intended functionality when evaluating syntax, ensuring that proposed corrections align with the overall goals of the code generation task.

In some implementations, the syntactic evaluation engine 122 may include an automated correction mechanism that can apply fixes to identified syntax issues. This mechanism may range from simple error corrections, such as adding missing semicolons or correcting indentation, to more complex refactoring operations that improve code structure and readability. The engine may generate multiple correction options for each identified issue, allowing other components of the system or human reviewers to select the most appropriate fix based on context and preferences. Additionally, the syntactic evaluation engine 122 may maintain a learning component that tracks common syntax errors and successful corrections over time, potentially improving its ability to suggest effective fixes for future code generation tasks.

The semantic validation engine 124 may be designed to perform a comprehensive analysis of the generated code's functionality and correctness without relying on code execution or comparison to pre-existing reference solutions. In some implementations, the semantic validation engine 124 may leverage natural language processing techniques and machine learning models to interpret both the original action description and the generated code. This approach may allow the engine to construct semantic representations of the intended functionality and the actual code implementation, facilitating a more nuanced comparison that goes beyond surface-level syntax matching.

In some cases, the semantic validation engine 124 may employ a multi-step validation process that includes generating intermediate representations of the code's functionality. For example, the semantic validation engine 124 may first produce a high-level description of the code's operations, then break this down into more granular functional units. These units may be compared against corresponding elements derived from the original action description. The semantic validation engine 124 may identify specific areas where the generated code may deviate from the intended functionality. The semantic validation engine 124 may incorporate domain-specific knowledge and coding best practices into its analysis, enabling it to evaluate not just the correctness of the code but also its efficiency, maintainability, and adherence to relevant standards or guidelines.

The semantic validation engine 124 may work in conjunction with other components of the system, such as the reasoning engine 120 and the syntactic evaluation engine 122, to provide a holistic assessment of the generated code. In some implementations, the semantic validation engine 124 may generate confidence scores or probability distributions for different aspects of the code's correctness, facilitating a more nuanced evaluation that captures degrees of alignment with the intended functionality. This probabilistic approach may be useful in scenarios where multiple valid implementations are possible, or where the original action description leaves room for interpretation. The results produced by the semantic validation engine 124 may be used to guide further refinements to the code generation process, potentially improving the overall quality and reliability of the system's outputs over time.

The feedback component 126 processes evaluation results and may be configured to obtain feedback based on reasoning explanations. In some implementations, the feedback component 126 may generate a RAG prompt for the ML component 118 and obtain feedback based on the RAG prompt. The feedback component 126 may identify errors associated with generated code and potential solutions to generate the RAG prompt.

The feedback component 126 may be designed to process and synthesize evaluation results from various components of the system, such as the reasoning engine 120, syntactic evaluation engine 122, and semantic validation engine 124. In some implementations, the feedback component 126 may analyze these evaluation results to identify patterns, common issues, and areas for improvement in the generated code. This analysis may involve aggregating feedback from multiple evaluation cycles, prioritizing issues based on their potential impact on code functionality and quality, and generating actionable insights that can be used to refine the code generation process.

In some cases, the feedback component 126 may employ machine learning techniques to enhance its feedback generation capabilities. For example, the feedback component 126 may utilize natural language processing models to translate technical evaluation results into more human-readable feedback that can be easily understood by developers or incorporated into subsequent code generation iterations. The feedback component 126 may maintain a knowledge base of common coding issues and their solutions, which may be updated and refined over time based on the system's performance across various code generation tasks.

The feedback component 126 may interface with the prompt generator 116 to create refined prompts that incorporate learnings from previous code generation attempts. In some implementations, this may involve generating RAG prompts that combine the original action description with relevant context, examples, and guidance derived from the feedback analysis. By iteratively refining prompts based on accumulated feedback, the system may be able to improve its code generation performance over time, potentially leading to more accurate, efficient, and maintainable code outputs.

The data store 128 maintains relevant data for the system operations. In some implementations, the data store 128 may store code catalogs, embedding representations, and other data used in code retrieval and generation processes. The data store 128 may serve as a centralized repository for storing and managing various types of data used by the code manager 112 and its components. In some implementations, the data store 128 may utilize a combination of relational databases, NoSQL databases, and file systems to efficiently organize and retrieve different data structures. The data store 128 may contain code catalogs that include pre-existing code snippets, functions, and modules categorized by programming language, functionality, and domain. These code catalogs may be used by the code retrieval process to quickly identify and retrieve relevant code examples that match incoming action requests.

In some cases, the data store 128 may store embedding representations of code snippets and natural language descriptions. These embeddings may be high-dimensional vector representations generated by machine learning models, capturing semantic and syntactic features of the code and associated descriptions. The embedding representations may facilitate efficient similarity searches and facilitate the retrieval of contextually relevant code examples. In some implementations, the data store 128 may maintain historical data on code generation attempts, including prompts, generated code, evaluation results, and feedback. This historical data may be used to train and fine-tune the various machine learning components of the system, potentially improving the accuracy and effectiveness of code generation and evaluation over time.

The data store 128 may include configuration data for the various components of the code manager 112, such as language-specific syntax rules, coding style guidelines, and customizable evaluation criteria. In some implementations, the data store 128 may employ caching mechanisms to improve access speeds for frequently used data, and may implement data versioning to track changes in code catalogs, embeddings, and other stored information over time. The data store 128 may be designed with scalability in mind, allowing for the efficient handling of growing datasets as the system processes more code generation tasks and accumulates additional knowledge.

The computing devices 104 and 106 may interact with the code manager 112 through the network 110 to utilize the code evaluation and generation capabilities. In some implementations, the computing devices 104 and 106 may serve as end-user devices for submitting code generation requests or receiving evaluation results.

The computing devices 104 and 106 may be implemented as various types of electronic devices capable of communicating with the code manager 112 through the network 110. These devices may include, but are not limited to, desktop computers, laptop computers, tablets, smartphones, wearable devices, or specialized hardware designed for specific code generation and evaluation tasks. In some implementations, the computing devices 104 and 106 may be equipped with user interface components such as displays, keyboards, touchscreens, or voice input systems to facilitate user interaction with the code management system.

The computing devices 104 and 106 may run specialized software applications or web-based interfaces that allow users to formulate code generation requests, view evaluation results, and interact with the generated code. These applications may provide features such as syntax highlighting, code editing capabilities, and visualization tools to help users understand and refine the generated code. In some cases, the computing devices 104 and 106 may also include local processing capabilities to perform preliminary code analysis or to cache frequently used code snippets, potentially reducing the load on the central code manager 112 and improving response times for common tasks.

In some implementations, the computing devices 104 and 106 may be configured to operate in different modes depending on the user's role or the specific requirements of the code generation task. For example, a device may be set up in a “developer mode” with advanced code editing and debugging tools, or in an “administrator mode” with access to system configuration settings and performance metrics. The computing devices 104 and 106 may be capable of operating in offline modes, allowing users to continue working on code generation tasks even when network connectivity to the code manager 112 is temporarily unavailable, with synchronization occurring once the connection is reestablished.

The data source 108 provides data that can be accessed by the components of the computing environment 100 through the network 110. In some implementations, the data source 108 may include repositories of code examples, programming language specifications, or other resources used in code generation and evaluation processes. In some implementations, the data source 108 may be any entity, computing system, model, website, computing device, or data store from which the computing system 102, the computing device 104, and/or the computing device 106 may obtain data.

In operation, the action processing engine 114 may receive an action from one of the computing devices 104 or 106. The action may be decomposed into atomic sub-actions, which are then processed to generate prompts using the prompt generator 116. The ML component 118 may generate code based on these prompts. The generated code may then undergo evaluation by the syntactic evaluation engine 122 and semantic validation engine 124. The reasoning engine 120 may extract explanations associated with the code's functional correctness. Based on these evaluations and explanations, the feedback component 126 may generate feedback, which is used to refine prompts for subsequent code generation. In some implementations, the code manager 112 may perform code retrieval processes using embedding representations and retrieval algorithms before initiating code generation. This may allow the system to efficiently reuse existing code when appropriate.

FIG. 1B is a diagram of an example of a process for automated code evaluation and enhancement using large language models. In some implementations, one or more aspects of the process may be performed by the code manager 112 of FIG. 1A.

The process begins with an action 132, which represents an indication of an action to be performed by generated code. In some implementations, the action 132 may include a system administration operation or a shell script task. The action 132 is provided as input to a decision step 134, which determines whether a catalog exists for the given action.

If a catalog exists, the process follows the “Yes” path to the code retrieval process 136. The code retrieval process 136 is configured to efficiently reuse existing code when appropriate. In some implementations, the code retrieval process 136 may include accessing an automation code catalog 140, which stores pre-existing code snippets and modules. The automation code catalog 140 interfaces with the ML component 118, which may be configured to generate embedding representations 142A and 142B. These embedding representations may capture semantic and syntactic features of the code snippets and associated descriptions. In some implementations, the ML component 118 may utilize natural language processing techniques to create these representations.

The embedding representations 142A and 142B are then processed by a retrieval algorithm 144. The retrieval algorithm 144 may be configured to perform similarity searches and identify contextually relevant code examples based on the input action. In some implementations, the retrieval algorithm 144 may employ various machine learning techniques, such as cosine similarity or nearest neighbor search, to find the most appropriate code matches.

The output of the retrieval algorithm 144 feeds into a decision step 146, which determines if there is high confidence in the retrieved code. This confidence assessment may be based on various factors, such as the similarity score between the retrieved code and the input action, or the historical performance of the retrieved code in similar contexts.

If the decision step 146 determines there is high confidence in the retrieved code (following the “Yes” path), the process proceeds directly to generate a final script 154. In some implementations, the final script 154 may represent the output of the overall process, providing code that is expected to perform the indicated action with high reliability. If the decision step 134 determines that no catalog exists for the given action, or if the decision step 146 determines there is not high confidence in the retrieved code, the process follows the “No” path to the code generation process 138. The code generation process 138 is designed to create new code when existing code is not suitable or available.

The code generation process 138 begins with a prompt generator 116, which may be configured to create structured inputs for the ML component 118 based on the action 132. In some implementations, the prompt generator 116 may utilize templates or schemas to format the action information into a standardized prompt structure optimized for the specific large language model being used.

The ML component 118 receives the prompt from the prompt generator 116 and generates code 148A based on this input. In some implementations, the ML component 118 may be an LLM specifically trained for code generation tasks. The generated code 148A represents the initial output of the code generation process. Following the generation of code 148A, an evaluation operation 150 is performed. The evaluation operation 150 may be configured to determine, using the machine learning component, a functionality of the generated code. In some implementations, this may involve performing a semantic validation operation without executing the generated code or comparing the generated code to a ground truth reference.

The evaluation operation 150 may include extracting a reasoning explanation associated with the functional correctness of the generated code. This explanation may provide insights into why the generated code is considered functionally correct or incorrect, facilitating further improvements and refinements. Based on the results of the evaluation operation 150, an enhancement operation 152 is performed. The enhancement operation 152 may be configured to obtain feedback based on the reasoning explanation and generate a refined prompt by refining the original prompt. This refined prompt may be used to improve subsequent code generation by the LLM.

In some implementations, the enhancement operation 152 may involve identifying syntactic or semantic corrections based on the reasoning explanation. It may also include generating a RAG prompt for the machine learning component to obtain more targeted feedback. The output of the enhancement operation 152, like the high-confidence path from the code retrieval process, leads to the final script 154. This final script represents the culmination of either the code retrieval or code generation process, providing code that is expected to perform the indicated action effectively. In some implementations, the process illustrated in FIG. 1B may be iterative, with the final script 154 potentially feeding back into the system for further refinement or serving as a new entry in the automation code catalog 140 for future use. This iterative approach may facilitate continual improvement of the code generation and retrieval processes over time.

The process shown in FIG. 1B efficiently combines code retrieval and generation capabilities, ensuring that the system can leverage existing code when possible while also having the flexibility to generate new code when needed. The integration of evaluation and enhancement operations allows for seamless refinement of generated code, thereby enhancing the overall quality and reliability of the automated code evaluation and enhancement system.

FIG. 1C is a diagram of an example of a process for action processing and prompt generation. In some implementations, one or more aspects of the process may be performed by the action processing engine 114 and prompt generator 116 of FIG. 1A.

The process begins with an action 132, which represents an indication of an action to be performed by generated code. In some implementations, the action 132 may include a system administration operation or a shell script task. The action 132 is provided as input to an action segmentation operation 156.

The action segmentation operation 156 may be configured to decompose the action 132 into one or more atomic sub-actions. In some implementations, the action segmentation operation 156 may utilize natural language processing techniques to analyze the action 132 and identify distinct steps or components that can be processed independently. The output of the action segmentation operation 156 includes any number of atomic sub-actions such as atomic sub-actions 132A and 132B. Atomic sub-actions 132A and 132B represent the individua tasks derived from the original action 132. In some implementations, these atomic sub-actions may correspond to specific system commands, data manipulation operations, or discrete computational steps. The granularity of the atomic sub-actions may facilitate more precise evaluation and processing in subsequent stages of the workflow.

The atomic sub-actions 132A and 132B are provided as input to a decision step 158. The decision step 158 may be configured to determine whether each atomic sub-action is automatable. In some implementations, this determination may involve analyzing the nature of the sub-action, checking for the availability of necessary resources or permissions, and assessing the feasibility of automated execution. For example, this step may involve determining whether the atomic sub-action is an action that can be performed by generated code.

If the decision step 158 determines that an atomic sub-action is not automatable, the process follows the “No” path to step 160. Step 160 may be configured to drop the non-automatable atomic sub-action from further processing. This step facilitates proceeding with only actionable and automatable tasks through the workflow, potentially improving the efficiency and reliability of the code generation process.

For atomic sub-actions determined to be automatable, the process follows the “Yes” path from decision step 158 to an action completion operation 162. The action completion operation 162 may be configured to enhance or refine the automatable atomic sub-actions with additional context or specifications. In some implementations, if the action is not complete, the action completion operation 162 incorporates associated information 164 into the processing of the automatable atomic sub-actions. In some implementations, the associated information 164 may include system-specific details, user preferences, environmental variables, or other contextual data that may be relevant to the execution of the atomic sub-actions. This incorporation of associated information 164 may facilitate the generation of more accurate and context-aware prompts for code generation.

The output of the action completion operation 162 is provided to a prompt generator 116. The prompt generator 116 may be configured to create structured inputs for the machine learning component 118 based on the processed atomic sub-actions and associated information. In some implementations, the prompt generator 116 may utilize templates or schemas to format the action information into a standardized prompt structure optimized for the specific large language model being used.

The prompt generator 116 may employ various techniques to create effective prompts for code generation. In some implementations, the prompt generator 116 may utilize rule-based prompt generation techniques, which may involve predefined sets of rules and heuristics to construct prompts based on the characteristics of the input action and the desired output. These rules may be designed to capture common patterns and structures in code generation tasks, allowing for consistent and predictable prompt creation.

In some implementations, the prompt generator 116 may leverage machine learning techniques to dynamically generate and refine prompts. This approach may involve training models on large datasets of successful code generation examples, enabling the prompt generator to learn optimal prompt structures and content over time. The machine learning-based prompt generation may adapt to different coding styles, programming languages, and task complexities, potentially improving the overall quality and relevance of the generated prompts.

The process illustrated in FIG. 1C decomposes complex actions into manageable atomic sub-actions, evaluates their automatability, and incorporates relevant contextual information to generate refined prompts for code generation. This approach may facilitate more precise and context-aware code generation, potentially improving the overall quality and applicability of the generated code in various system administration and shell scripting scenarios.

FIG. 1D is a diagram of an example of a process for automated code evaluation and enhancement using large language models. In some implementations, one or more aspects of the process may be performed by the code manager 112 of FIG. 1A.

The process begins with an action 132, which represents an indication of an action to be performed by generated code. In some implementations, the action 132 may include a system administration operation or a shell script task. The action 132 is provided as input to a prompt creation operation 116A, which may be configured to generate a prompt for code generation based on the received action. The prompt creation operation 116A interfaces with an ML component 118, which may be an LLM configured to generate code based on the provided prompt. In some implementations, the ML component 118 may include multiple machine learning models or algorithms working in conjunction to process the input and generate appropriate code outputs.

The ML component 118 produces generated code 148A based on the prompt received from the prompt creation operation 116A. The generated code 148A represents the initial output of the code generation process and may include various programming constructs and logic to perform the indicated action. Following the generation of code 148A, a bash script syntax checking operation 122A is performed. This operation may be configured to analyze the generated code for syntactic correctness, specifically focusing on bash script syntax. In some implementations, the bash script syntax checking operation 122A may utilize specialized parsers or static analysis tools to identify potential syntax errors or style violations.

The results of the bash script syntax checking operation 122A are then processed by another prompt creation operation 116B. This operation may be configured to generate a new prompt based on the syntax checking results, potentially requesting corrections or clarifications for any identified syntax issues.

The prompt creation operation 116B may generate a structured input that encapsulates the syntax checking results and any identified issues. This prompt may include details about specific syntax errors, their locations within the code, and potential corrections or alternatives. In some implementations, the prompt may incorporate contextual information about the original action and the intended functionality of the code to guide the correction process.

The ML component 118 receives this syntax-focused prompt and processes it to generate syntactically correct code 148B. In this iteration, the ML component 118 may leverage its understanding of bash script syntax and common coding patterns to address the identified issues. The ML component 118 may analyze the provided syntax error information, consider the suggested corrections, and apply its knowledge to modify the code accordingly. In some cases, the ML component 118 may generate multiple alternative corrections for a given syntax issue. The ML component 118 may evaluate these alternatives based on factors such as code readability, efficiency, and adherence to best practices. The ML component 118 may consider the broader context of the code and ensure that syntax corrections do not inadvertently alter the intended functionality.

The syntactically correct code 148B produced by the ML component 118 may incorporate the necessary fixes while preserving the original logic and purpose of the code. In some implementations, the ML component 118 may provide explanations or comments alongside the corrected code, detailing the changes made and the reasoning behind them. This approach may enhance transparency and facilitate learning for both the system and potential human reviewers.

A prompt creation operation 116C may be initiated to generate a prompt for code explanation. This prompt may be designed to elicit a comprehensive description of the code's functionality, including its purpose, key components, and expected behavior. The ML component 118 processes this prompt to generate a code explanation 168, which may provide valuable context for subsequent semantic validation steps.

The code explanation 168 generated by the ML component 118 may provide a detailed breakdown of the syntactically correct code 148B. This explanation may include a high-level overview of the code's purpose, as well as more granular descriptions of individual functions, loops, and conditional statements. In some implementations, the code explanation 168 may use natural language to describe the logic flow, data structures, and algorithms employed in the code. The explanation may highlight key variables, their purposes, and how they interact within the code. In some cases, the code explanation 168 may include examples of expected inputs and outputs, helping to illustrate the code's behavior under different scenarios. The ML component 118 may generate explanations that are tailored to different levels of technical expertise, potentially providing both simplified overviews and more in-depth technical descriptions.

In some implementations, the code explanation 168 may include annotations or comments inline with the code snippets, providing context-specific explanations for particular code blocks or lines. This approach may help in understanding the rationale behind specific coding decisions and how they contribute to the overall functionality. The code explanation 168 may address potential edge cases or limitations of the generated code, providing insights into how the code might behave under unusual or extreme conditions. In some cases, the explanation may suggest possible optimizations or alternative approaches that could be considered for improving the code's performance or robustness.

By providing a comprehensive code explanation 168, the system may facilitate better understanding and validation of the generated code, potentially bridging the gap between the technical implementation and the original action requirements. This explanatory step may be particularly valuable in scenarios where the generated code is to be reviewed, modified, or integrated into existing systems by human developers or system administrators.

Another prompt creation operation 116D is configured to generate a prompt for code checking. This prompt is provided to the ML component 118, which performs a semantic validation operation to determine the functional correctness of the generated code without executing the code or comparing it to a ground truth reference. The semantic validation engine 124 receives inputs from both the code explanation 168 and the ML component 118's code checking output. In some implementations, the semantic validation engine 124 may be configured to compare the intended functionality (derived from the code explanation) with the actual functionality (determined through semantic analysis) to assess the correctness of the generated code. In some implementations, the semantic validation engine 124 may employ various techniques to perform its analysis, such as symbolic reasoning or machine learning-based prediction of code behavior. The semantic validation engine 124 may generate detailed explanations of its findings, potentially including step-by-step breakdowns of the code's logical flow and assessments of how well the code addresses different aspects of the original task.

The process culminates in an output 170 that combines the syntactically correct script 148B, code explanation 168, and semantic validation 124A results. This comprehensive output may provide a holistic view of the generated code, including its syntactic correctness, functional description, and semantic validity.

The output 170 may be utilized in various ways to enhance the code generation and evaluation process. In some implementations, the combined information from the syntactically correct script 148B, code explanation 168, and semantic validation 124A results may serve as a comprehensive report for developers or system administrators. This report may provide valuable insights into the generated code's structure, functionality, and correctness without requiring manual code execution or comparison to reference solutions. In some cases, the output 170 may be used as input for further refinement of the code generation process. The semantic validation results may highlight areas where the generated code does not fully meet the intended functionality, potentially triggering additional iterations of code generation or prompting human intervention for complex cases.

The process illustrated in FIG. 1D demonstrates a multi-faceted approach to code generation and evaluation, incorporating syntax checking, semantic validation, and natural language explanation generation. This approach may facilitate more robust and reliable code generation, potentially improving the overall quality and correctness of automatically generated code for various system administration and shell scripting tasks.

In some implementations, the process may include additional feedback loops or refinement stages. For example, the semantic validation results could be used to further refine the code generation prompts, potentially leading to iterative improvements in the generated code's functionality and correctness. By combining syntactic and semantic evaluation with natural language explanations, the process may facilitate better understanding and validation of generated code, potentially bridging the gap between automated code generation and human comprehension. This approach may be particularly valuable in scenarios where generated code needs to be reviewed or integrated into existing systems by human developers or system administrators.

FIG. 1E is a diagram of an example of a process for performing semantic validation of generated code. In some implementations, one or more aspects of the process may be performed by the semantic validation engine 124 of FIG. 1A.

The semantic validation engine 124 receives a prompt 124B and code functionality 124C as inputs. In some implementations, the prompt 124B may include a natural language representation of an action to be performed by generated code. The prompt 124B may be generated by the prompt generator 116 based on an indication of an action received from a user or system. The code functionality 124C may include a description or representation of the functionality of code generated by an LLM in response to the prompt 124B.

The semantic validation engine 124 includes a similarity analysis module 124D and a difference analysis module 124E. In some implementations, the similarity analysis module 124D may be configured to determine a set of similarity evidence items based on performing a similarity analysis associated with the prompt 124B and the code functionality 124C. The similarity analysis module 124D may employ natural language processing techniques to identify common concepts, structures, or intentions between the prompt and the generated code functionality.

The difference analysis module 124E may be configured to determine a set of difference evidence items based on performing a difference analysis associated with the prompt 124B and the code functionality 124C. In some implementations, the difference analysis module 124E may identify discrepancies, missing elements, or potential misalignments between the intended action specified in the prompt and the actual functionality of the generated code.

The outputs of the similarity analysis module 124D and the difference analysis module 124E are provided to evidence extraction modules 124F and 124G, respectively. In some implementations, the evidence extraction modules may be configured to process the results of the similarity and difference analyses to extract specific, actionable evidence items. These evidence items may represent points of alignment or divergence between the prompt and the code functionality.

The evidence extraction module 124F processes the output of the similarity analysis module 124D to extract similarity evidence items. These items may include specific code structures, functional elements, or semantic concepts that align closely with the intended action specified in the prompt. In some implementations, the similarity evidence items may be represented as structured data, allowing for easier comparison and ranking in subsequent stages of the process.

Similarly, the evidence extraction module 124G processes the output of the difference analysis module 124E to extract difference evidence items. These items may highlight areas where the generated code functionality deviates from or fails to fully address the requirements specified in the prompt. In some implementations, the difference evidence items may include suggestions for potential improvements or modifications to better align the code with the intended action.

The extracted evidence items from both the similarity and difference analyses are then provided to an evidence ranking module 124H. In some implementations, the evidence ranking module 124H may be configured to evaluate and prioritize the evidence items based on their relevance, importance, and potential impact on the overall functional correctness of the generated code.

The evidence ranking module 124H may employ various techniques to rank the evidence items. In some implementations, ranking the evidence items may involve performing additional similarity or difference analyses to assess the consistency of each item across multiple evaluations. The evidence ranking module 124H may assign, to each item of the set of similarity evidence items or the set of difference evidence items, a respective consistency score of a plurality of consistency scores. The respective consistency score may correspond to a number of times that a respective item appears across multiple analyses.

In some implementations, the evidence ranking module 124H may utilize a validation-based approach for ranking. This may involve determining an expected output of the generated code based on the evidence items, generating a sample output using the generated code and a sample input corresponding to an evidence item, and determining a validation score based on a comparison between the expected output and the sample output. The evidence items may then be ranked based on these validation scores.

The ranked evidence items are provided as input to a semantic validation module 124A. In some implementations, the semantic validation module 124A may be configured to determine the functional correctness of the generated code based on the ranked evidence items. The semantic validation module 124A may analyze the relative importance and implications of the similarity and difference evidence to make a holistic assessment of how well the generated code aligns with the intended action specified in the prompt.

The semantic validation module 124A generates a semantic validation output, which may include a determination of the functional correctness of the generated code. In some implementations, this output may also include a reasoning explanation associated with the functional correctness of the generated code. The reasoning explanation may include at least one of the set of similarity evidence items or the set of difference evidence items, providing insight into why the code is considered functionally correct or incorrect.

In this configuration, the semantic validation engine 124 facilitates the evaluation of generated code without requiring code execution or comparison to a ground truth reference. The integration of similarity and difference analyses, evidence extraction, and ranking allows for a nuanced assessment of code functionality, potentially improving the accuracy and reliability of automated code generation systems. The semantic validation output may be used to generate feedback and refine prompts, leading to iterative improvements in the code generation process.

FIG. 1F is a diagram of an example of a process for processing and generating feedback for code refinement. In some implementations, one or more aspects of the process may be performed by the feedback component 126 of FIG. 1A.

The process begins with human and/or model feedback 126A, which serves as the initial input for the feedback processing pipeline. In some implementations, the human and/or model feedback 126A may include evaluations, comments, or suggestions related to generated code. This feedback may originate from human experts reviewing the code or from automated model-based assessments. The human and/or model feedback 126A may be structured in various formats, such as natural language comments, numerical ratings, or predefined categories of feedback.

The human and/or model feedback 126A flows to a sentiment extraction module 126B. This module may be configured to analyze the emotional tone or overall attitude expressed in the feedback. In some implementations, the sentiment extraction module 126B may employ natural language processing techniques to categorize the feedback as positive, negative, or neutral. The sentiment information extracted at this stage may be used to prioritize or weight different aspects of the feedback in subsequent processing steps. The sentiment extraction module 126B may play facilitate prioritizing feedback. In some implementations, feedback with strongly negative sentiment may be given higher priority, as it may indicate more critical issues that need immediate attention. Conversely, positive sentiment feedback may be used to reinforce successful code generation patterns or highlight areas of the code that are particularly well-implemented.

Following the sentiment extraction, the process continues to a key symptom/evidence extraction module 126C. This module may be configured to identify and extract specific issues, errors, or areas of improvement mentioned in the feedback. In some implementations, the key symptom/evidence extraction module 126C may utilize machine learning algorithms to recognize patterns or common problems in the feedback. The extracted information may include code snippets, error messages, performance metrics, or descriptions of unexpected behavior. The key symptom/evidence extraction module 126C may be designed to handle a wide range of feedback types. In some implementations, this module may be capable of processing both structured feedback (e.g., standardized error reports or performance metrics) and unstructured feedback (e.g., free-form text comments from human reviewers). The module may employ advanced natural language understanding techniques to extract relevant information from complex or technical descriptions.

The information extracted by the key symptom/evidence extraction module 126C then flows to a retrieval based context generation stage 126D. This module may be configured to gather relevant contextual information based on the extracted symptoms or evidence. In some implementations, the retrieval based context generation module 126D may query databases, documentation, or previous code examples to provide additional context for the identified issues. This context may include relevant coding standards, best practices, or similar problems and their solutions from past experiences. The retrieval based context generation module 126D may leverage large-scale knowledge bases to provide comprehensive context for identified issues. In some implementations, this module may access not only internal code repositories and documentation but also external resources such as open-source libraries, coding forums, or academic publications. The context generated by this module may help in understanding the root causes of identified problems and in suggesting potential solutions based on established best practices or similar cases.

The feedback component 126 also includes a fine tuned model for feedback prompt generation 126E. This model may be configured to process inputs from both the human/model feedback 126A and the retrieval based context generation 126D. In some implementations, the fine tuned model 126E may be an LLM specifically trained on code-related feedback and refinement tasks. The model may analyze the original feedback, extracted sentiments and symptoms, and the generated context to produce refined feedback prompts.

The fine tuned model 126E may generate prompts that are tailored to improve subsequent code generation by the LLM. In some implementations, these prompts may include specific instructions for code modifications, suggestions for alternative approaches, or requests for clarification on certain aspects of the code. The prompts generated by the fine tuned model 126E may be structured in a way that facilitates clear communication between the feedback system and the code generation LLM.

The fine tuned model for feedback prompt generation 126E may be continually updated based on the effectiveness of its generated prompts. In some implementations, the model may track how well its prompts lead to improved code in subsequent iterations, and use this information to refine its prompt generation strategies. This adaptive approach may allow the feedback system to become more effective over time, learning from its successes and failures to produce increasingly relevant and actionable feedback.

The process illustrated in FIG. 1F may facilitate iterative refinement of generated code. In some implementations, the refined prompts produced by the fine tuned model 126E may be fed back into the code generation process, potentially leading to improved code outputs in subsequent iterations. This feedback loop may allow for continuous improvement of the code generation system over time.

In this configuration, the feedback component 126 facilitates a sophisticated process for analyzing, contextualizing, and refining feedback on generated code. The integration of sentiment analysis, key symptom extraction, context generation, and prompt refinement allows for a nuanced and adaptive approach to code improvement. This process may enhance the overall quality and reliability of the code generation system by providing targeted, context-aware feedback that can be directly incorporated into subsequent code generation iterations.

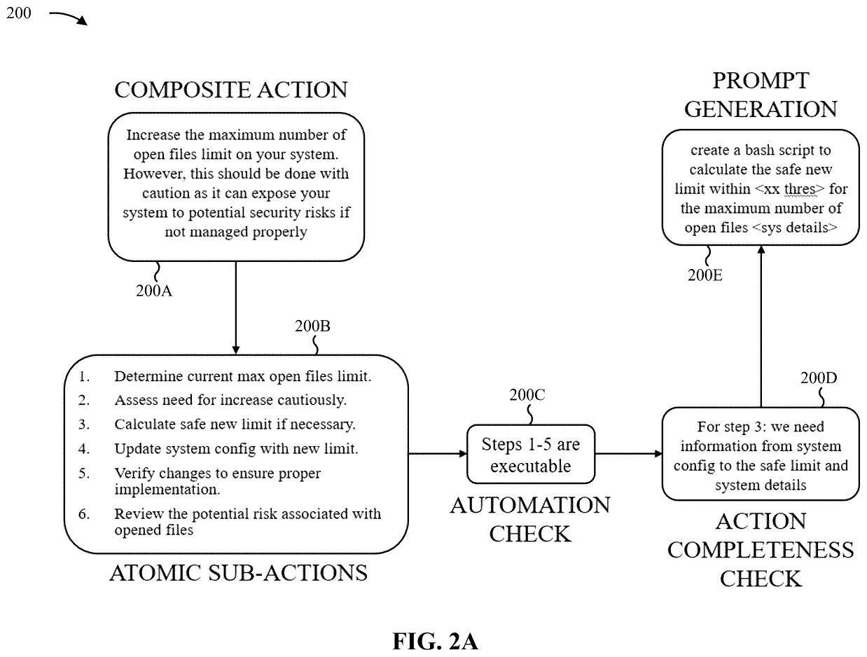

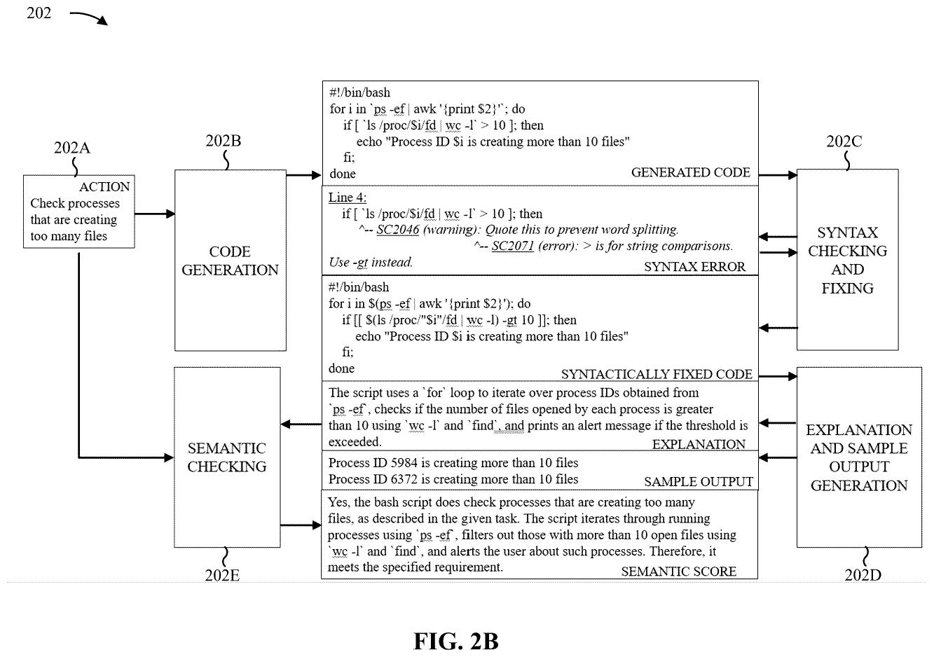

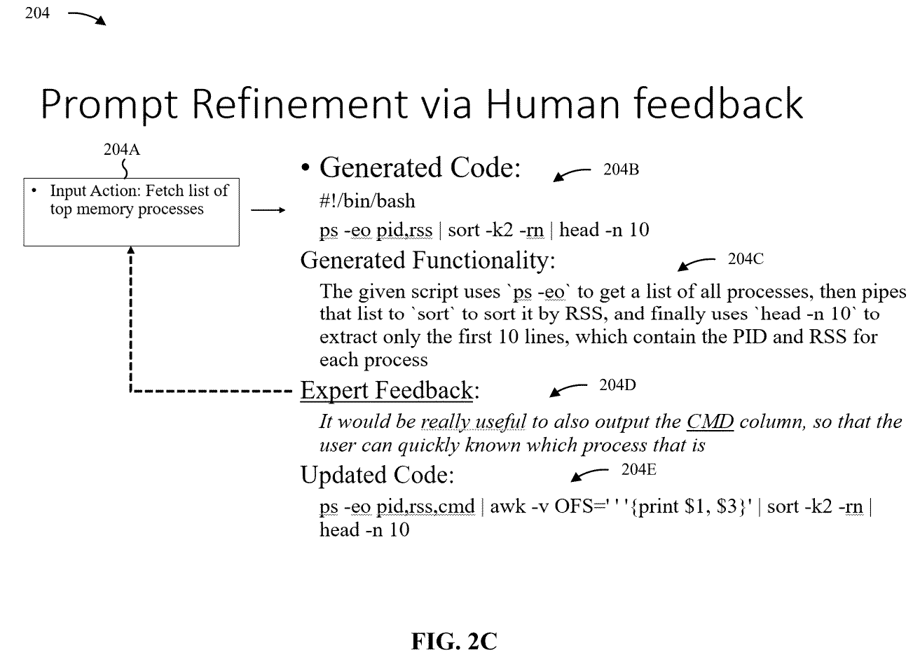

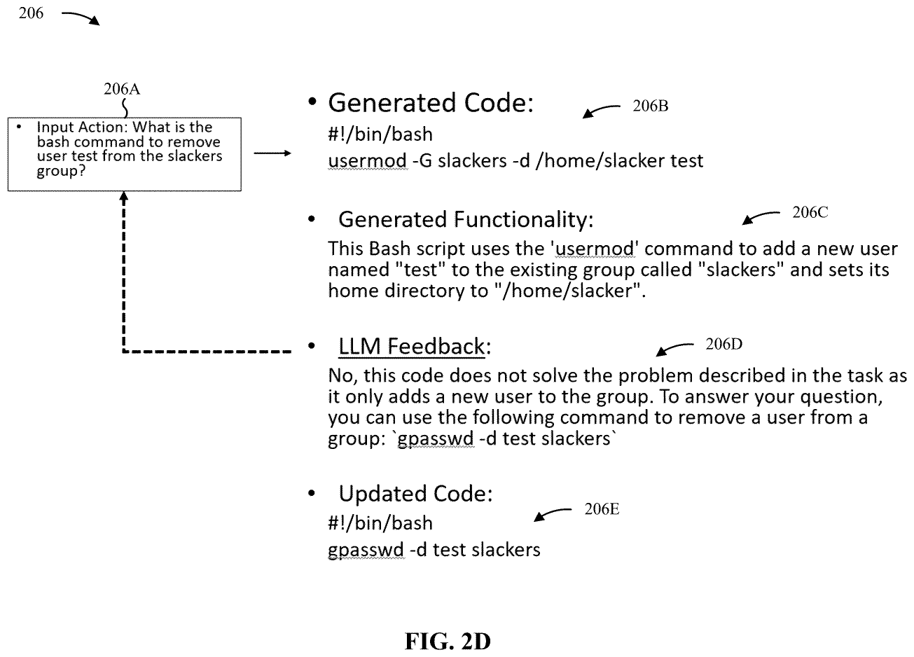

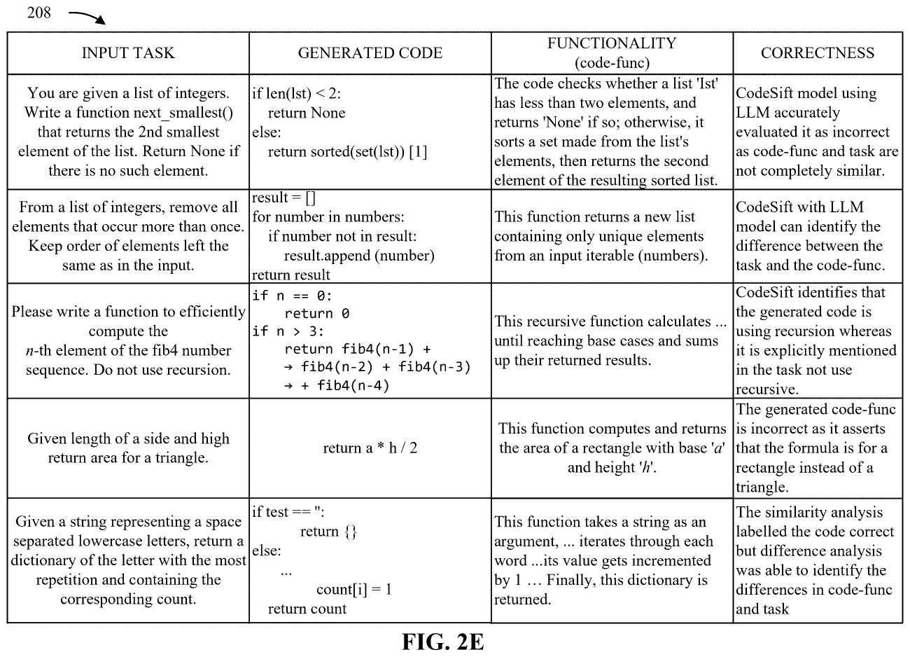

FIGS. 2A-2E are schematic diagrams showing examples of associated with automated code evaluation and enhancement described herein.

FIG. 2A illustrates an example 200 of a process for refining and generating code using the system described in this disclosure. The example 200 depicts a workflow that begins with a composite action 200A describing an operation to increase the maximum number of open files limit on a system, along with a cautionary note about potential security risks. In some implementations, the composite action 200A may be received by the action processing engine 114 of FIG. 1A as an input for code generation.

The composite action 200A flows to atomic sub-actions 200B, which breaks down the operation into six discrete steps. These steps include determining the current maximum open files limit, assessing the need for increase, calculating a safe new limit, updating system configuration, verifying changes, and reviewing potential risks associated with opened files. The decomposition of the composite action 200A into atomic sub-actions 200B may be performed by the action segmentation operation 156 described in FIG. 1C.

An automation check 200C connects to the atomic sub-actions 200B, indicating that steps 1-5 are executable. This automation check 200C may correspond to the decision step 158 in FIG. 1C, where the system determines whether each atomic sub-action is automatable. In some implementations, the automation check 200C may be performed by the action processing engine 114 to identify which sub-actions can be processed for code generation.

The workflow continues with an action completeness check 200D, which specifies that for step 3, information is needed from system configuration regarding the safe limit and system details. This action completeness check 200D may be similar to the action completion operation 162 described in FIG. 1C, where associated information 164 is incorporated to enhance or refine the automatable atomic sub-actions.

In some implementations, the action completeness check 200D may be performed by the action processing engine 114 to ensure that all necessary information is available for generating accurate and context-aware prompts. If the action is determined to be incomplete, the system may obtain completion information from one or more external systems, as described in the operations of the computer program product in claim 17.

The workflow concludes with prompt generation 200E, which creates a bash script to calculate the safe new limit within specified parameters for the maximum number of open files based on system details. This prompt generation 200E may correspond to the prompt generator 116 described in FIG. 1A and FIG. 1C, which is configured to create structured inputs for the machine learning component 118 based on the processed atomic sub-actions and associated information.

In some implementations, the prompt generation 200E may utilize various techniques to create effective prompts for code generation. These techniques may include rule-based prompt generation, which involves predefined sets of rules and heuristics to construct prompts based on the characteristics of the input action and the desired output. Alternatively, the prompt generation 200E may leverage machine learning techniques to dynamically generate and refine prompts, potentially adapting to different coding styles, programming languages, and task complexities.

The prompt generated in 200E may be used as input for the ML component 118 described in FIG. 1A and FIG. 1B. The ML component 118 may then generate code based on this prompt, initiating the code generation process 138 illustrated in FIG. 1B. In some implementations, the generated code may undergo evaluation and enhancement operations, as described in the evaluation operation 150 and enhancement operation 152 of FIG. 1B, to ensure its functional correctness and improve its quality.

FIG. 2B illustrates an example 202 of a code evaluation system for automated code evaluation and enhancement using large language models. The example 202 depicts a workflow that begins with an action 202A for checking processes that are creating too many files. In some implementations, the action 202A may be similar to the action 132 described in FIG. 1B, representing an indication of an action to be performed by generated code.

The action 202A connects to a code generation module 202B, which may be configured to generate initial code based on the action. In some implementations, the code generation module 202B may utilize the ML component 118 described in FIG. 1A and FIG. 1B to produce the generated code. The code generation module 202B may employ various techniques, such as natural language processing and machine learning algorithms, to interpret the action 202A and create corresponding code.

The code generation module 202B outputs generated code to a syntax checking and fixing module 202C. The syntax checking and fixing module 202C may be configured to perform syntax validation and correction on the generated code. In some implementations, the syntax checking and fixing module 202C may be similar to the syntactic evaluation engine 122 described in FIG. 1A. This module may employ static analysis techniques and language-specific parsing tools to identify potential syntax errors, style violations, and structural issues within the code.

The syntax checking and fixing module 202C outputs both the syntax error information and syntactically fixed code. This dual output may facilitate a more comprehensive evaluation process, allowing for both the identification of specific syntax issues and the provision of corrected code. In some implementations, the syntax checking and fixing module 202C may generate multiple correction options for each identified issue, potentially improving the flexibility and effectiveness of the code refinement process.

An explanation and sample output generation module 202D receives the syntactically fixed code from module 202C. Module 202D may be configured to generate a natural language explanation of the code's functionality along with sample output demonstrating the code's behavior. In some implementations, this module may utilize natural language processing techniques to translate the code's logic into human-readable descriptions. The generation of sample outputs may involve simulating the code's execution under various input conditions without actually running the code, potentially enhancing the safety and efficiency of the evaluation process.

A semantic checking module 202E receives input from both the action 202A and the explanation and sample output generation module 202D. The semantic checking module 202E may be configured to perform semantic validation by comparing the code's explained functionality against the original action requirements. In some implementations, the semantic checking module 202E may be similar to the semantic validation engine 124 described in FIG. 1A and FIG. 1E. This module may employ various analytical approaches, such as symbolic reasoning or machine learning-based prediction of code behavior, to assess the functional correctness of the generated code without executing it.

The semantic checking module 202E may generate detailed explanations of its findings, potentially including step-by-step breakdowns of the code's logical flow and assessments of how well the code addresses different aspects of the original task. In some implementations, this module may also identify areas where the generated code may deviate from best practices or introduce potential vulnerabilities, providing a comprehensive evaluation that goes beyond simple correctness checks.

FIG. 2C illustrates an example 204 of a prompt refinement system for processing and refining code based on feedback. The system depicted in FIG. 2C may be implemented as part of the code manager 112 described in FIG. 1A, particularly utilizing components such as the prompt generator 116, ML component 118, and feedback component 126.

The example 204 begins with an input action 204A specifying “Fetch list of top memory processes.” This input action 204A may be similar to the action 132 described in FIG. 1B and FIG. 1C, representing an indication of an action to be performed by generated code. In some implementations, the input action 204A may be received by the action processing engine 114 and decomposed into atomic sub-actions as described in FIG. 1C.

Based on the input action 204A, generated code 204B is produced. The generated code 204B contains a bash script “ps-eo pid, rss|sort-k2-rm|head-n 10” for retrieving process information. In some implementations, this code generation may be performed by the ML component 118 described in FIG. 1A and FIG. 1B, utilizing prompts created by the prompt generator 116.

The system includes generated functionality 204C that provides a description of what the generated code accomplishes. Specifically, the generated functionality 204C explains that the script uses ‘ps-eo’ to obtain a list of all processes, pipes that list to ‘sort’ to sort it by RSS, and finally uses ‘head-n 10’ to extract the first 10 lines containing PID and RSS information for each process. This functionality description may be generated by the semantic validation engine 124 described in FIG. 1A and FIG. 1E, as part of the process of determining the functional correctness of the generated code.

The system incorporates expert feedback 204D suggesting an improvement to the generated code. In this case, the expert feedback 204D recommends including the CMD column in the output to allow users to quickly identify which process corresponds to the displayed information. This feedback may be similar to the feedback processed by the feedback component 126 described in FIG. 1A and FIG. 1F.

In some implementations, the expert feedback 204D may be obtained through a process similar to that described in FIG. 1F, where human or model feedback is analyzed for sentiment, key symptoms or evidence are extracted, and relevant context is generated. The feedback may then be processed by a fine-tuned model to generate refined prompts for code improvement.

Based on the expert feedback 204D, updated code 204E is generated. The updated code 204E modifies the original script to “ps-eo pid, rss, cmd|awk-v OFS=′′′{print $1, $3}′|sort-k2-rm |head-n 10” to include the additional command information in the output. This code refinement process may be similar to the enhancement operation 152 described in FIG. 1B, where feedback is used to improve the generated code.

In some implementations, the updated code 204E may undergo further evaluation using the semantic validation engine 124 and syntactic evaluation engine 122 described in FIG. 1A to ensure that the modifications have not introduced new errors and that the code still meets the requirements of the original input action. This iterative process of code generation, evaluation, feedback, and refinement may facilitate the continuous improvement of the code generation system's outputs.

FIG. 2D illustrates an example 206 of a system for automated code evaluation and enhancement using large language models. The system depicted in FIG. 2D may be implemented as part of the code manager 112 described in FIG. 1A, utilizing components such as the prompt generator 116, ML component 118, and feedback component 126.

The example 206 begins with an input action 206A requesting a bash command to remove a user “test” from the “slackers” group. In some implementations, the input action 206A may be similar to the action 132 described in FIG. 1B and FIG. 1C, representing an indication of an action to be performed by generated code. The input action 206A may be received by the action processing engine 114 and potentially decomposed into atomic sub-actions as described in FIG. 1C.

Based on the input action 206A, generated code 206B is produced. The generated code 206B contains a bash script using the “usermod” command. In some implementations, this code generation may be performed by the ML component 118 described in FIG. 1A and FIG. 1B, utilizing prompts created by the prompt generator 116. The ML component 118 may employ various techniques, such as natural language processing and machine learning algorithms, to interpret the input action 206A and create corresponding code.

The system includes generated functionality 206C that describes what the generated code does. Specifically, the generated functionality 206C explains that the bash script uses the “usermod” command to add a new user named “test” to an existing group called “slackers” and sets its home directory to “/home/slacker”. This functionality description may be generated by the semantic validation engine 124 described in FIG. 1A and FIG. 1E, as part of the process of determining the functional correctness of the generated code.

In some implementations, the semantic validation engine 124 may employ various analytical approaches to assess the functional correctness of the generated code. For example, the semantic validation engine 124 may utilize symbolic reasoning techniques to logically deduce the effects and outcomes of the code execution without actually running the code. Additionally, the semantic validation engine 124 may incorporate machine learning models trained on large datasets of code-to-functionality mappings, enabling it to predict the likely behavior and output of the generated code.

The system incorporates LLM feedback 206D which analyzes the generated code and functionality. The feedback indicates that the code does not solve the problem described in the task since it only adds a new user to the group rather than removing one. The feedback provides the correct command using “gpasswd” to remove a user from a group. In some implementations, this feedback may be generated by the feedback component 126 described in FIG. 1A and FIG. 1F.

The feedback component 126 may process and synthesize evaluation results from various components of the system, such as the reasoning engine 120, syntactic evaluation engine 122, and semantic validation engine 124. In some implementations, the feedback component 126 may analyze these evaluation results to identify patterns, common issues, and areas for improvement in the generated code. This analysis may involve aggregating feedback from multiple evaluation cycles, prioritizing issues based on their potential impact on code functionality and quality, and generating actionable insights that can be used to refine the code generation process.

Based on the LLM feedback 206D, updated code 206E is generated containing a bash script that uses the “gpasswd” command to remove the user “test” from the “slackers” group, addressing the original request specified in the input action. This code refinement process may be similar to the enhancement operation 152 described in FIG. 1B, where feedback is used to improve the generated code. In some implementations, the updated code 206E may undergo further evaluation using the semantic validation engine 124 and syntactic evaluation engine 122 described in FIG. 1A to ensure that the modifications have not introduced new errors and that the code still meets the requirements of the original input action.

The iterative process of code generation, evaluation, feedback, and refinement illustrated in FIG. 2D may facilitate the continuous improvement of the code generation system's outputs. In some implementations, this process may be repeated multiple times, with each iteration potentially producing more accurate and effective code. The system may leverage the accumulated knowledge from previous iterations to enhance its performance over time, potentially leading to more efficient and reliable code generation for similar tasks in the future.

FIG. 2E illustrates an example 208 of a table showing evaluation results for different code generation and validation scenarios. The table presented in FIG. 2E may be generated by components of the code manager 112 described in FIG. 1A, such as the semantic validation engine 124 and the feedback component 126. In some implementations, the table may serve as a comprehensive output summarizing the performance of the code generation and evaluation system across multiple test cases.

The table in example 208 includes four columns: “INPUT TASK”, “GENERATED CODE”, “FUNCTIONALITY (code-func)”, and “CORRECTNESS”. This structure may facilitate a clear presentation of the relationship between input tasks, their corresponding generated code, and the evaluation results. In some implementations, the “INPUT TASK” column may contain natural language descriptions of actions to be performed, similar to the action 132 described in FIG. 1B and FIG. 1C. The “GENERATED CODE” column may display the code produced by the ML component 118 in response to these input tasks.

The “FUNCTIONALITY (code-func)” column in the table may provide descriptions of what the generated code does, similar to the generated functionality 204C and 206C described in FIG. 2C and FIG. 2D, respectively. These descriptions may be produced by the semantic validation engine 124 as part of its process of determining the functional correctness of the generated code without execution or comparison to ground truth references.

The “CORRECTNESS” column may present evaluation results from the CodeSift model, which may be implemented as part of the semantic validation engine 124 described in FIG. 1A and FIG. 1E. In some implementations, these results may indicate whether the generated code properly addresses the input task requirements and highlight any discrepancies between the task specifications and the generated code functionality.

One row in the table shows an input task requesting a function to return the second smallest element from a list of integers. The generated code for this task includes a conditional statement checking the list length and returning a sorted set element. This example may demonstrate the system's ability to handle tasks involving data structures and sorting operations, which may be common in various programming scenarios.

Another row in the table demonstrates code generation for removing duplicate elements from a list while maintaining the original order. The functionality column describes how the generated code processes the input list to create a new list with unique elements. This example may showcase the system's capability to generate code for data manipulation tasks, which may be particularly relevant in data processing and analysis applications.

The table in FIG. 2E includes an example of generating code for computing the nth element of a fib4 number sequence. In this case, the generated solution uses recursion despite the input task specifically requesting non-recursive implementation. This discrepancy may highlight the importance of the semantic validation process described in FIG. 1E, where the similarity analysis module 124D and difference analysis module 124E may facilitate identifying such misalignments between the input task and the generated code functionality.

Additional examples in the table show code generation for calculating triangle area and processing space-separated lowercase letters. These diverse examples may demonstrate the system's versatility in handling various types of programming tasks, from mathematical computations to string processing. In some implementations, the range of tasks presented in the table may be representative of the types of actions that can be processed by the action processing engine 114 described in FIG. 1A and FIG. 1C.

The “CORRECTNESS” column in the table provides evaluation results from the CodeSift model, indicating whether the generated code properly addresses the input task requirements. In some implementations, these results may be derived from the semantic validation process described in FIG. 1E, where evidence ranking module 124H may play a role in determining the overall correctness based on similarity and difference evidence items. The evaluation results presented in this column may serve as input for the feedback component 126 described in FIG. 1A and FIG. 1F, potentially guiding the generation of refined prompts for subsequent code generation iterations.

In some implementations, the table presented in FIG. 2E may be used as part of a larger evaluation and refinement process. For instance, the results displayed in this table may be analyzed by the feedback component 126 to identify patterns in successful or unsuccessful code generations. This analysis may inform the generation of RAG prompts, potentially leading to improvements in the code generation process over time.

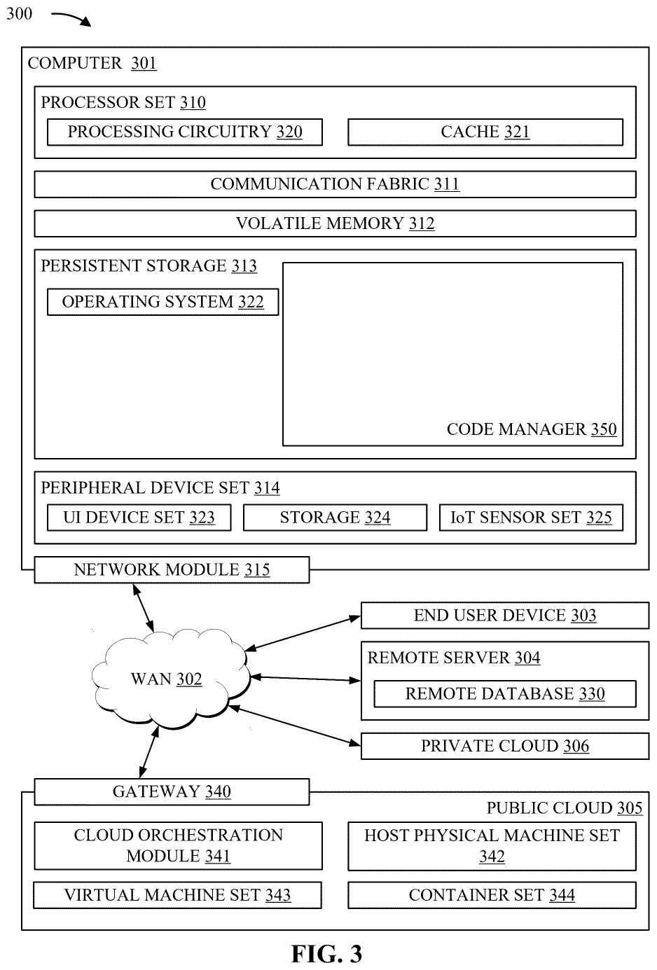

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The computing environment 300 contains an example of an environment for the execution of at least some of the computer code involved in performing the inventive methods, such as the code manager, shown in block 350. In addition to block 350, the computing environment 300 includes, for example, a computer 301, a WAN 302, an end user device (EUD) 303, a remote server 304, a public cloud 305, and a private cloud 306. In this embodiment, the computer 301 includes a processor set 310 (including processing circuitry 320 and a cache 321), a communication fabric 311, a volatile memory 312, persistent storage 313 (including an operating system 322 and a block 350, as identified above), a peripheral device set 314 (including a user interface (UI) device set 323, storage 324, and an Internet of Things (IoT) sensor set 325), and a network module 315. The remote server 304 includes a remote database 330. The public cloud 305 includes a gateway 340, a cloud orchestration module 341, a host physical machine set 342, a virtual machine set 343, and a container set 344.

The computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as a remote database 330. As is well understood in the art of computer technology, and depending upon the technology, performance of a computer-implemented method may be distributed among multiple computers and/or between multiple locations. On the other hand, in this presentation of the computing environment 300, detailed discussion is focused on a single computer, specifically the computer 301, to keep the presentation as simple as possible. The computer 301 may be located in a cloud, even though it is not shown in a cloud in FIG. 3. On the other hand, the computer 301 is not required to be in a cloud except to any extent as may be affirmatively indicated.

The processor set 310 includes one or more computer processors of any type now known or to be developed in the future. The processing circuitry 320 may be distributed over multiple packages, for example, multiple, coordinated integrated circuit chips. The processing circuitry 320 may implement multiple processor threads and/or multiple processor cores. The cache 321 is memory that is located in the processor chip package(s) and is typically used for data or code that should be available for rapid access by the threads or cores running on the processor set 310. Cache memories are typically organized into multiple levels depending upon relative proximity to the processing circuitry. Alternatively, some, or all, of the cache for the processor set may be located “off chip.” In some computing environments, the processor set 310 may be designed for working with qubits and performing quantum computing.

Computer readable program instructions are typically loaded onto the computer 301 to cause a series of operational steps to be performed by the processor set 310 of the computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 321 and the other storage media discussed below. The program instructions, and associated data, are accessed by the processor set 310 to control and direct performance of the inventive methods. In the computing environment 300, at least some of the instructions for performing the inventive methods may be stored in the block 350 in persistent storage 313.

The communication fabric 311 is the signal conduction path that allows the various components of the computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 312 is any type of volatile memory now known or to be developed in the future. Examples include dynamic type RAM or static type RAM. Typically, the volatile memory 312 is characterized by random access, but this is not required unless affirmatively indicated. In the computer 301, the volatile memory 312 is located in a single package and is internal to the computer 301, but, alternatively or additionally, the volatile memory 312 may be distributed over multiple packages and/or located externally with respect to the computer 301.

The persistent storage 313 is any form of non-volatile storage for computers that is now known or to be developed in the future. The non-volatility of this storage means that the stored data is maintained regardless of whether power is being supplied to the computer 301 and/or directly to the persistent storage 313. The persistent storage 313 may be a ROM, but typically at least a portion of the persistent storage allows writing of data, deletion of data and re-writing of data. Some familiar forms of persistent storage include magnetic disks and solid state storage devices. The operating system 322 may take several forms, such as various known proprietary operating systems or open source Portable Operating System Interface-type operating systems that employ a kernel. The code included in block 350 typically includes at least some of the computer code involved in performing the inventive methods.

The peripheral device set 314 includes the set of peripheral devices of the computer 301. Data communication connections between the peripheral devices and the other components of the computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 323 may include components such as a display screen, speaker, microphone, wearable devices (such as goggles and smart watches), keyboard, mouse, printer, touchpad, game controllers, and haptic devices. The storage 324 is external storage, such as an external hard drive, or insertable storage, such as an SD card. The storage 324 may be persistent and/or volatile. In some embodiments, the storage 324 may take the form of a quantum computing storage device for storing data in the form of qubits. In embodiments where the computer 301 is required to have a large amount of storage (for example, where the computer 301 locally stores and manages a large database) then this storage may be provided by peripheral storage devices designed for storing very large amounts of data, such as a storage area network (SAN) that is shared by multiple, geographically distributed computers. The IoT sensor set 325 is made up of sensors that can be used in Internet of Things applications. For example, one sensor may be a thermometer and another sensor may be a motion detector.

The network module 315 is the collection of computer software, hardware, and firmware that allows the computer 301 to communicate with other computers through the WAN 302. The network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 315 are performed on the same physical hardware device. In other embodiments (for example, embodiments that utilize software-defined networking (SDN)), the control functions and the forwarding functions of the network module 315 are performed on physically separate devices, such that the control functions manage several different network hardware devices. Computer readable program instructions for performing the inventive methods can typically be downloaded to the computer 301 from an external computer or external storage device through a network adapter card or network interface included in the network module 315.

The WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The EUD 303 is any computer system that is used and controlled by an end user (for example, a customer of an enterprise that operates the computer 301) and may take any of the forms discussed above in connection with the computer 301. The EUD 303 typically receives helpful and useful data from the operations of computer 301. For example, in a hypothetical case where the computer 301 is designed to provide a recommendation to an end user, this recommendation would typically be communicated from the network module 315 of the computer 301 through the WAN 302 to the EUD 303. In this way, the EUD 303 can display, or otherwise present, the recommendation to an end user. In some embodiments, the EUD 303 may be a client device, such as thin client, heavy client, mainframe computer, desktop computer and so on.

The remote server 304 is any computer system that serves at least some data and/or functionality to the computer 301. The remote server 304 may be controlled and used by the same entity that operates the computer 301. The remote server 304 represents the machine(s) that collect and store helpful and useful data for use by other computers, such as the computer 301. For example, in a hypothetical case where the computer 301 is designed and programmed to provide a recommendation based on historical data, then this historical data may be provided to the computer 301 from the remote database 330 of the remote server 304.

The public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 305 is performed by the computer hardware and/or software of the cloud orchestration module 341. The computing resources provided by the public cloud 305 are typically implemented by virtual computing environments that run on various computers making up the computers of the host physical machine set 342, which is the universe of physical computers in and/or available to the public cloud 305. The virtual computing environments (VCEs) typically take the form of virtual machines from the virtual machine set 343 and/or containers from the container set 344. It is understood that these VCEs may be stored as images and may be transferred among and between the various physical machine hosts, either as images or after instantiation of the VCE. The cloud orchestration module 341 manages the transfer and storage of images, deploys new instantiations of VCEs and manages active instantiations of VCE deployments. The gateway 340 is the collection of computer software, hardware, and firmware that allows the public cloud 305 to communicate through the WAN 302.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 306 is similar to the public cloud 305, except that the computing resources are only available for use by a single enterprise. While the private cloud 306 is depicted as being in communication with the WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 305 and the private cloud 306 are both part of a larger hybrid cloud.

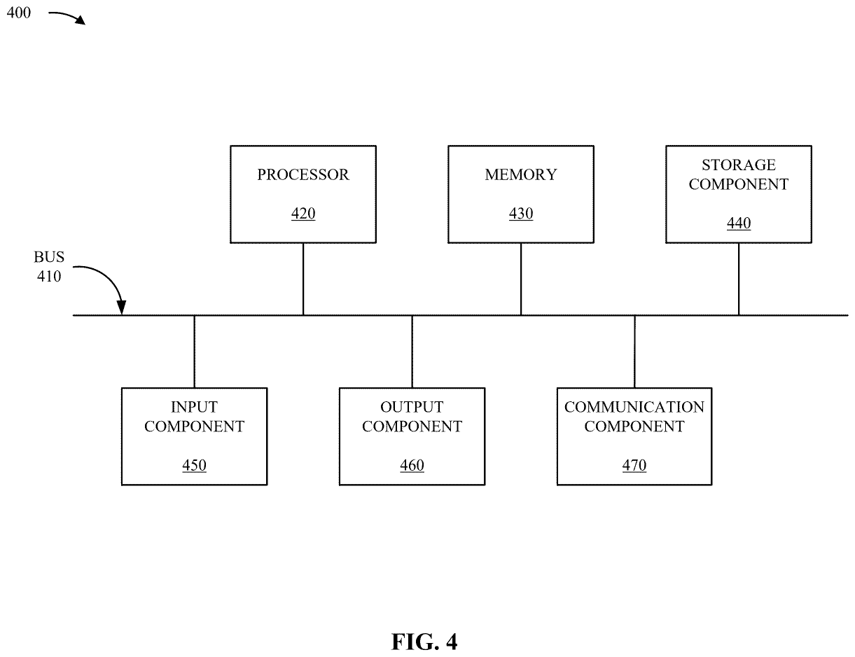

FIG. 4 is a diagram of example components of a device 400, which may implement one or more components of the computing environment 100. In some implementations, the device 400 may be, be similar to, include, or be included in the computer 301 shown in FIG. 3. The device 400 may be, be similar to, include, or be included in, an apparatus for performing one or more methods, processes, algorithms, operations, tasks, and/or techniques, as described herein. The device 400 may be, be similar to, include, or be included in, a computing device, a laptop, a workstation, a server device, or a personal computer, among other examples. As shown in FIG. 4, device 400 may include a bus 410 that interconnects various components or units, such as a processor 420, a memory 430, a storage component 440, an input component 450, an output component 460, and a communication component 470.

The processor 420 may be a central processing unit, such as a microprocessor, and may include single or multiple processors having single or multiple processing cores. The processor 420 may include another type of device, or multiple devices, configured for manipulating or processing information. For example, the processor 420 may include multiple processors interconnected in one or more manners, including hardwired or networked. The operations of the processor 420 may be distributed across multiple devices or units that can be coupled directly or across a local area or other suitable type of network. The processor 420 may include a cache, or cache memory, for local storage of operating data or instructions. The processor 420 is implemented in hardware, firmware, or a combination of hardware and software. In some implementations, the processor 420 includes one or more processors capable of being programmed to perform a function. In some implementations, the processor 420 may be, be similar to, include, or be included in processor set 310 shown in FIG. 3.

The memory 430 includes one or more memory components, which may each be volatile memory or non-volatile memory. The memory 430 may include non-transitory memory. The volatile memory can be RAM (e.g., a DRAM module, such as DDR SDRAM). The non-volatile memory of the memory 430 may be a disk drive, a solid state drive, flash memory, or phase-change memory. In some implementations, the memory 430 may be distributed across multiple devices. For example, the memory 430 may include network-based memory or memory in multiple clients or servers performing the operations of those multiple devices.

The memory 430 may include data for access by the processor 420. For example, the memory 430 may include executable instructions, application data, or an operating system, among other examples. The executable instructions may include one or more application programs, which may be loaded or copied, in whole or in part, from non-volatile memory to volatile memory to be executed by the processor 420. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The storage component 440 stores information and/or software related to the operation of the device 400. For example, the storage component 440 may include a hard disk drive, a magnetic disk drive, an optical disk drive, a solid state disk drive, a compact disc, a digital versatile disc, and/or another type of non-transitory computer-readable medium. The storage component 440 may be, be similar to, include, or be included in, the memory 430.

The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, and/or an actuator. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, and/or an antenna.

The device 400 may perform one or more processes described herein. For example, a non-transitory computer-readable medium (e.g., the memory 430 and/or the storage component 440) may store a set of instructions (e.g., one or more instructions, code, software code, and/or program code) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

The terms “processor,” “processing circuitry,” “processor set,” or “controller” may refer to one or more processors. For example, reference to “a/the processor,” “a/the processor set,” or the like (in the singular) should be understood to refer to any one or more of the processors described in connection with FIGS. 3 and 4, such as a single processor or a combination of multiple different processors. Reference to “one or more processors” should be understood to refer to any one or more of the processors described in connection with FIGS. 3 and 4.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIGS. 3 and 4. For example, operation described as being performed by one or more memories can be performed by the same subset of the one or more memories or different subsets of the one or more memories. Additionally or alternatively, in some examples, one or more of the processors may be preconfigured to perform various functions or operations described herein without requiring configuration by software.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

An “engine” refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. s used herein, the term “model” encompasses its plain and ordinary meaning. A model may include, among other things, one or more engines which receive an input and compute an output based on the input.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

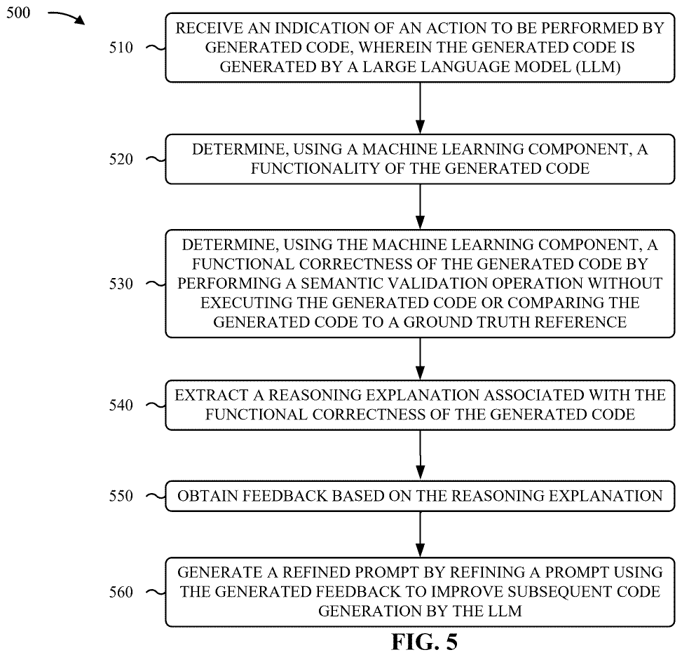

To further describe some implementations in greater detail, reference is next made to examples of techniques which may be performed by or using an AI system as described herein. FIG. 5 is a flowchart of an example of a technique 500 associated with automated code evaluation and enhancement using large language models. The technique 500 can be executed using computing devices, such as the systems, hardware, and software described with respect to FIGS. 1A-4. The technique 500 can be performed, for example, by executing a machine-readable program or other computer-executable instructions, such as routines, instructions, programs, or other code. The steps, or operations, of the technique 500, or another technique, method, process, or algorithm described in connection with the implementations disclosed herein can be implemented directly in hardware, firmware, software executed by hardware, circuitry, or a combination thereof.

For simplicity of explanation, the technique 500 is depicted and described herein as a series of steps or operations. However, the steps or operations of the technique 500 can occur in various orders and/or concurrently. Additionally, other steps or operations not presented and described herein may be used. Furthermore, not all illustrated steps or operations may be required to implement a technique in accordance with the disclosed subject matter.

At 510, the technique 500 may include receiving an indication of an action to be performed by generated code, wherein the generated code is generated by an LLM. In some implementations, this action may include a system administration operation or a shell script task. The indication of the action may be received by a component of the system, such as the action processing engine 114 described in FIG. 1A.

In some implementations, prior to generating the code, the technique 500 may include decomposing the action into one or more atomic sub-actions. This decomposition process may facilitate more granular processing and evaluation of complex tasks. The system may determine whether each atomic sub-action is automatable, and generate a prompt based on determining that the atomic sub-action is automatable. Additionally, the system may determine, based on the one or more atomic sub-actions, whether the action is complete or incomplete. If the action is determined to be complete, the system may generate the prompt based on this determination. Conversely, if the action is determined to be incomplete, the system may obtain completion information from one or more external systems.

At 520, the technique 500 may include determining, using a machine learning component, a functionality of the generated code. This step may involve analyzing the structure and logic of the generated code to understand its intended behavior and outputs. In some implementations, the machine learning component may utilize natural language processing techniques to generate a textual description of the generated code's functionality.

At 530, the technique 500 may include determining, using the machine learning component, a functional correctness of the generated code by performing a semantic validation operation without executing the generated code or comparing the generated code to a ground truth reference. This semantic validation operation may involve comparing the textual description of the generated code to a natural language representation of the action. In some implementations, the semantic validation operation may include determining a set of similarity evidence items based on performing a similarity analysis associated with the action and the functionality, and determining a set of difference evidence items based on performing a difference analysis associated with the action and the functionality.

The semantic validation operation may further include ranking the similarity evidence items or the difference evidence items, wherein the functional correctness is based on this ranking. In some implementations, the ranking process may involve performing additional similarity or difference analyses and assigning consistency scores to each item based on the number of times it appears across multiple analyses. In some implementations, the ranking process may involve determining an expected output of the generated code based on the evidence items, generating a sample output using the generated code and a sample input corresponding to an evidence item, determining a validation score based on a comparison between the expected output and the sample output, and ranking the evidence items based on the validation score.

At 540, the technique 500 may include extracting a reasoning explanation associated with the functional correctness of the generated code. In some implementations, this reasoning explanation may include at least one of the set of similarity evidence items or the set of difference evidence items identified during the semantic validation operation. The reasoning explanation may provide insights into why the generated code is considered functionally correct or incorrect, facilitating further improvements and refinements.

At 550, the technique 500 may include obtaining feedback based on the reasoning explanation. In some implementations, obtaining the feedback may involve generating a RAG prompt for the machine learning component and obtaining the feedback based on this RAG prompt. The process of generating the RAG prompt may include identifying at least one error associated with the generated code, identifying at least one potential solution associated with the identified error, and generating the RAG prompt based on information indicative of the error and the potential solution. In some implementations, the RAG prompt may be generated based on a sentiment associated with the prompt, allowing for more nuanced and context-aware feedback generation.

At 560, the technique 500 may include generating a refined prompt by refining a prompt using the generated feedback to improve subsequent code generation by the LLM. This step may involve incorporating the insights and corrections identified through the feedback process into the prompt structure, potentially leading to more accurate and effective code generation in future iterations. In some implementations, the system may generate updated code based on this refined prompt, initiating a new cycle of code generation and evaluation.

In some implementations, the technique 500 may include additional steps or variations of the described steps. For example, the system may employ different machine learning models or algorithms for various stages of the process, such as code generation, semantic validation, or feedback analysis. The technique 500 may incorporate adaptive learning mechanisms, allowing the system to improve its performance over time based on accumulated experience and feedback.

The technique 500 may be particularly useful in scenarios where traditional code evaluation methods, such as execution-based testing or comparison to predefined reference solutions, are impractical or insufficient. For instance, in system administration tasks or operations that interact with specific hardware or network setups, the ability to evaluate code correctness without execution may provide significant advantages in terms of safety and efficiency.

In some implementations, the technique 500 may be extended to handle multi-modal inputs, allowing it to process actions specified through various means such as natural language, flowcharts, or pseudocode. This flexibility may enhance the system's ability to address a wide range of code generation and evaluation scenarios across different domains and use cases.

According to an aspect of the disclosure, there is provided a computer-implemented method. The method includes receiving an indication of an action to be performed by generated code, where the generated code is generated by an LLM. The method determines, using a machine learning component, a functionality of the generated code. It also determines, using the machine learning component, a functional correctness of the generated code by performing a semantic validation operation without executing the generated code or comparing the generated code to a ground truth reference. The method extracts a reasoning explanation associated with the functional correctness of the generated code, obtains feedback based on the reasoning explanation, and generates a refined prompt by refining a prompt using the generated feedback to improve subsequent code generation by the LLM. This method improves the efficiency and accuracy of code evaluation by eliminating the need for code execution or comparison to reference solutions. Additionally, the method enables continuous improvement of code generation through iterative refinement based on semantic analysis and feedback.

In embodiments, the semantic validation operation can include generating, using the machine learning component, a textual description of the generated code, and comparing the textual description of the generated code to a natural language representation of the action. This approach has the technical effect of enabling more nuanced and context-aware code evaluation without relying on syntactic comparisons or execution results.

In embodiments, the semantic validation operation can include determining a set of similarity evidence items based on performing a similarity analysis associated with the action and the functionality, and determining a set of difference evidence items based on performing a difference analysis associated with the action and the functionality. This technique has the technical effect of providing a more comprehensive evaluation of code correctness by considering both similarities and differences between intended and actual functionality.

In embodiments, the reasoning explanation can include at least one of the set of similarity evidence items or the set of difference evidence items. This feature has the technical effect of providing transparent and interpretable explanations for the code evaluation results, facilitating better understanding and targeted improvements.

In embodiments, the semantic validation operation can further include ranking the at least one of the set of similarity evidence items or the set of difference evidence items, where the functional correctness is based on the ranking. This ranking approach has the technical effect of prioritizing the most relevant evidence for determining code correctness, potentially improving the accuracy of the evaluation.

In embodiments, ranking the evidence items can include performing at least one of an additional similarity analysis or an additional difference analysis, assigning consistency scores to each item based on the number of times it appears, and ranking the items based on the consistency scores. This technique has the technical effect of improving the reliability of the evaluation by considering the consistency of evidence across multiple analyses.

In embodiments, ranking the evidence items can include determining an expected output of the generated code based on the evidence items, generating a sample output using the generated code and a sample input corresponding to an evidence item, determining a validation score based on a comparison between the expected output and the sample output, and ranking the evidence items based on the validation score. This approach has the technical effect of providing a more robust evaluation by considering the practical outputs of the code in addition to its structural characteristics.

In embodiments, generating the feedback can include identifying, based on the reasoning explanation, at least one of a syntactic correction or a semantic correction. This feature has the technical effect of providing targeted and actionable feedback for improving the generated code.

In embodiments, obtaining the feedback can include generating a RAG prompt for the machine learning component and obtaining the feedback based on the RAG prompt. This technique has the technical effect of leveraging additional context and knowledge to generate more relevant and effective feedback.

In embodiments, generating the RAG prompt can include identifying at least one error associated with the generated code, identifying at least one potential solution associated with the error, and generating the RAG prompt based on information indicative of the error and the potential solution. This approach has the technical effect of providing more specific and solution-oriented feedback for code improvement.

In embodiments, generating the RAG prompt can include generating the RAG prompt based on a sentiment associated with the RAG prompt. This feature has the technical effect of incorporating emotional or tonal context into the feedback generation process, potentially leading to more nuanced and effective code refinement.

In embodiments, the action can include a system administration operation or a shell script task. This feature has the technical effect of enabling the method to address complex, system-level programming tasks that may be particularly challenging to evaluate using traditional methods.

According to another aspect of the disclosure, there is provided a computer program product including one or more computer-readable storage media and program instructions stored on the one or more computer-readable storage media to perform operations. The operations are the same as those described for the computer-implemented method above. This computer program product provides the same technical effects and advantages as the method, while offering the additional benefit of being easily distributable and installable on various computing systems.

In embodiments, the operations can further include decomposing the action into one or more atomic sub-actions prior to generating the code. This feature has the technical effect of enabling more granular processing and evaluation of complex tasks.

In embodiments, the operations can further include determining whether an atomic sub-action is automatable and generating the prompt based on determining that the atomic sub-action is automatable. This approach has the technical effect of focusing computational resources on feasible code generation tasks.

In embodiments, the operations can further include determining, based on the one or more atomic sub-actions, that the action is complete and generating the prompt based on determining that the action is complete. This feature has the technical effect of ensuring that all necessary information is available before initiating code generation.

In embodiments, the operations can further include determining, based on the one or more atomic sub-actions, that the action is incomplete and obtaining completion information from one or more systems based on determining that the action is incomplete. This approach has the technical effect of enabling the system to handle more complex and context-dependent tasks by dynamically gathering necessary information.

According to yet another aspect of the disclosure, there is provided a computer system including a processor set, one or more computer-readable storage media, and program instructions stored on the one or more computer-readable storage media to cause the processor set to perform operations. The operations are the same as those described for the computer-implemented method above. This computer system provides the same technical effects and advantages as the method, while offering the additional benefit of being a dedicated hardware solution for code evaluation and enhancement.

In embodiments, the action can include a system administration operation or a shell script task. This feature has the technical effect of enabling the system to address complex, system-level programming tasks that may be particularly challenging to evaluate using traditional methods.

In embodiments, the operations can further include generating updated code based on the refined prompt. This feature has the technical effect of completing the feedback loop, allowing for iterative improvement of the generated code based on the evaluation and feedback processes.

In one implementation, a computer-implemented method includes receiving an indication of an action to be performed by generated code, where the generated code is generated by a large language model (LLM). The method determines, using a machine learning component, a functionality of the generated code and a functional correctness of the generated code by performing a semantic validation operation without executing the generated code or comparing the generated code to a ground truth reference. The semantic validation operation includes generating, using the machine learning component, a textual description of the generated code and comparing the textual description of the generated code to a natural language representation of the action. The method extracts a reasoning explanation associated with the functional correctness of the generated code, obtains feedback based on the reasoning explanation, and generates a refined prompt by refining a prompt using the generated feedback to improve subsequent code generation by the LLM. This implementation provides the technical effect of enabling efficient and accurate code evaluation without the need for code execution or reference comparisons, while also facilitating natural language-based semantic validation. The generation of a textual description of the code and its comparison to a natural language representation of the action offers the specific technical advantage of bridging the gap between code syntax and human-readable task descriptions, potentially improving the accuracy of functional correctness assessments.

In a further implementation, the computer-implemented method described above also includes determining a set of similarity evidence items based on performing a similarity analysis associated with the action and the functionality, and determining a set of difference evidence items based on performing a difference analysis associated with the action and the functionality. This implementation provides the technical effect of enhancing the semantic validation process by considering both similarities and differences between the intended action and the generated code's functionality. The use of similarity and difference analyses offers the specific technical advantage of providing a more comprehensive and nuanced evaluation of the code's correctness, potentially capturing subtle discrepancies that might be missed by simpler comparison methods.

In another implementation, the computer-implemented method described above further includes that the reasoning explanation includes at least one of the set of similarity evidence items or the set of difference evidence items. This implementation provides the technical effect of generating more transparent and interpretable explanations for the code's functional correctness. The inclusion of specific evidence items in the reasoning explanation offers the specific technical advantage of providing concrete, actionable insights that can be used to improve the code generation process or guide human review of the generated code.

In yet another implementation, the computer-implemented method described above also includes ranking the at least one of the set of similarity evidence items or the set of difference evidence items, where the functional correctness is based on the ranking. This implementation provides the technical effect of prioritizing the most relevant evidence for determining code correctness. The ranking process offers the specific technical advantage of focusing the evaluation on the most significant aspects of similarity or difference, potentially improving the accuracy and efficiency of the functional correctness assessment.

In a further implementation, the computer-implemented method described above includes ranking the at least one of the set of similarity evidence items or the set of difference evidence items by performing at least one of an additional similarity analysis or an additional difference analysis, assigning to each item a respective consistency score corresponding to a number of times that a respective item appears, and ranking the items based on the consistency scores. This implementation provides the technical effect of enhancing the reliability and robustness of the evidence ranking process. The use of consistency scores based on multiple analyses offers the specific technical advantage of identifying and prioritizing evidence items that are consistently relevant across different evaluation approaches, potentially reducing the impact of noise or outliers in the assessment.

In another implementation, the computer-implemented method described above includes ranking the at least one of the set of similarity evidence items or the set of difference evidence items by determining an expected output of the generated code based on the evidence items, generating a sample output using the generated code and a sample input corresponding to an evidence item, determining a validation score based on a comparison between the expected output and the sample output, and ranking the evidence items based on the validation score. This implementation provides the technical effect of grounding the evidence ranking process in practical, output-based evaluations. The generation and comparison of sample outputs offers the specific technical advantage of assessing the code's correctness based on its actual behavior, even without full execution, potentially capturing functional discrepancies that might not be apparent from static analysis alone.

In one implementation, a computer-implemented method includes receiving an indication of an action to be performed by generated code, where the generated code is generated by a large language model (LLM). The method determines, using a machine learning component, a functionality of the generated code and a functional correctness of the generated code by performing a semantic validation operation without executing the generated code or comparing the generated code to a ground truth reference. The method extracts a reasoning explanation associated with the functional correctness of the generated code and obtains feedback based on the reasoning explanation. The feedback is generated by identifying, based on the reasoning explanation, at least one of a syntactic correction or a semantic correction. The method generates a refined prompt by refining a prompt using the generated feedback to improve subsequent code generation by the LLM. This implementation provides the technical effect of enabling targeted improvements to the generated code based on specific identified corrections. The distinction between syntactic and semantic corrections offers the specific technical advantage of addressing both structural and functional aspects of the code, potentially leading to more comprehensive and effective refinements.

In another implementation, a computer-implemented method includes receiving an indication of an action to be performed by generated code, where the generated code is generated by a large language model (LLM). The method determines, using a machine learning component, a functionality of the generated code and a functional correctness of the generated code by performing a semantic validation operation without executing the generated code or comparing the generated code to a ground truth reference. The method extracts a reasoning explanation associated with the functional correctness of the generated code and obtains feedback based on the reasoning explanation. The feedback is obtained by generating a RAG prompt for the machine learning component and obtaining the feedback from the machine learning component based on the RAG prompt. The method generates a refined prompt by refining a prompt using the generated feedback to improve subsequent code generation by the LLM. This implementation provides the technical effect of leveraging additional context and knowledge in the feedback generation process. The use of RAG prompts offers the specific technical advantage of incorporating relevant external information into the feedback, potentially leading to more informed and effective code refinements.

In one implementation, a computer program product includes one or more computer-readable storage media and program instructions stored on the one or more computer-readable storage media to perform operations. The operations include receiving an indication of an action to be performed by generated code, where the generated code is generated by a large language model (LLM), determining a functionality and a functional correctness of the generated code using a machine learning component, extracting a reasoning explanation associated with the functional correctness, obtaining feedback based on the reasoning explanation, and generating a refined prompt to improve subsequent code generation. The operations also include decomposing the action into one or more atomic sub-actions prior to generating the code. This implementation provides the technical effect of enabling more granular processing and evaluation of complex tasks. The decomposition into atomic sub-actions offers the specific technical advantage of breaking down complex actions into manageable units, potentially improving the accuracy and efficiency of both code generation and evaluation processes.

In a further implementation, the computer program product described above also includes operations for determining whether an atomic sub-action is automatable and generating the prompt based on determining that the atomic sub-action is automatable. This implementation provides the technical effect of focusing computational resources on feasible code generation tasks. The automatability check offers the specific technical advantage of filtering out sub-actions that cannot be effectively translated into code, potentially improving the overall efficiency and relevance of the code generation process.

In another implementation, the computer program product described above includes operations for determining, based on the one or more atomic sub-actions, that the action is complete and generating the prompt based on determining that the action is complete. This implementation provides the technical effect of ensuring that all necessary information is available before initiating code generation. The completeness check offers the specific technical advantage of preventing the generation of incomplete or incorrect code due to insufficient input information, potentially improving the overall quality and reliability of the generated code.

In yet another implementation, the computer program product described above includes operations for determining, based on the one or more atomic sub-actions, that the action is incomplete and obtaining completion information from one or more systems based on determining that the action is incomplete. This implementation provides the technical effect of enabling the system to handle more complex and context-dependent tasks. The ability to obtain completion information dynamically offers the specific technical advantage of adapting to varying levels of input completeness, potentially expanding the range of tasks that can be effectively processed by the system.

In one implementation, a computer system includes a processor set, one or more computer-readable storage media, and program instructions stored on the one or more computer-readable storage media to cause the processor set to perform operations. The operations include receiving an indication of an action to be performed by generated code, where the generated code is generated by a large language model (LLM), determining a functionality and a functional correctness of the generated code using a machine learning component, extracting a reasoning explanation associated with the functional correctness, obtaining feedback based on the reasoning explanation, generating a refined prompt to improve subsequent code generation, and generating updated code based on the refined prompt. This implementation provides the technical effect of enabling a complete feedback loop for iterative code improvement. The generation of updated code based on the refined prompt offers the specific technical advantage of continuously enhancing the quality and correctness of the generated code through multiple iterations, potentially leading to more robust and effective code outputs over time.

In one implementation, the automated code evaluation and enhancement system effectively improves the quality of generated shell scripts for system administration tasks. When a system administrator requests a script to “increase the maximum number of open files limit on the system”, the action processing engine decomposes this composite action into atomic sub-actions. These sub-actions include determining the current maximum open files limit, assessing the need for an increase, calculating a safe new limit, updating system configuration, and verifying changes. The system then generates a bash script to calculate and set the safe new limit based on system details.

The semantic validation engine analyzes the generated script without execution, comparing its functionality to the original request. For instance, it may identify that the script correctly retrieves the current limit and updates the system configuration, but fails to include a safety check to prevent setting an excessively high limit. The reasoning engine extracts this discrepancy as part of its explanation, which is then used to generate feedback. The feedback component, utilizing a retrieval-augmented generation approach, incorporates relevant system administration best practices and security considerations into a refined prompt. This prompt guides the large language model to generate an improved script that includes the necessary safety checks.

In another example, the system processes a request to “remove user ‘test’ from the ‘slackers’ group”. The initial code generation produces a script using the “usermod” command, which incorrectly adds the user to the group instead of removing them. The semantic validation engine detects this functional mismatch without executing the potentially harmful code. The feedback component then generates a RAG prompt highlighting the error and suggesting the use of the “gpasswd” command for user removal from groups. This leads to the generation of a corrected script that accurately performs the intended action, demonstrating the system's ability to iteratively improve code quality and correctness for critical system administration tasks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
receiving an indication of an action to be performed by generated code, wherein the generated code is generated by a large language model (LLM);
determining, using a machine learning component, a functionality of the generated code;
determining, using the machine learning component, a functional correctness of the generated code by performing a semantic validation operation without executing the generated code or comparing the generated code to a ground truth reference;
extracting a reasoning explanation associated with the functional correctness of the generated code;
obtaining feedback based on the reasoning explanation; and
generating a refined prompt by refining a prompt using the generated feedback to improve subsequent code generation by the LLM.

2. The computer-implemented method of claim 1, wherein performing the semantic validation operation comprises:
generating, using the machine learning component, a textual description of the generated code; and
comparing the textual description of the generated code to a natural language representation of the action.

3. The computer-implemented method of claim 1, wherein performing the semantic validation operation comprises:
determining a set of similarity evidence items based on performing a similarity analysis associated with the action and the functionality; and
determining a set of difference evidence items based on performing a difference analysis associated with the action and the functionality.

4. The computer-implemented method of claim 3, wherein the reasoning explanation comprises at least one of the set of similarity evidence items or the set of difference evidence items.

5. The computer-implemented method of claim 4, wherein performing the semantic validation operation further comprises:
ranking the at least one of the set of similarity evidence items or the set of difference evidence items, wherein the functional correctness is based on the ranking.

6. The computer-implemented method of claim 5, wherein ranking the at least one of the set of similarity evidence items or the set of difference evidence items comprises:
performing at least one of an additional similarity analysis or an additional difference analysis;
assigning, to each item of the at least one of the set of similarity evidence items or the set of difference evidence items, a respective consistency score of a plurality of consistency scores, wherein the respective consistency score corresponds to a number of times that a respective item appears; and
ranking the at least one of the set of similarity evidence items or the set of difference evidence items based on the plurality of consistency scores.

7. The computer-implemented method of claim 5, wherein ranking the at least one of the set of similarity evidence items or the set of difference evidence items comprises:
determining an expected output of the generated code based on the at least one of the set of similarity evidence items or the set of difference evidence items;
generating, using the generated code and based on a sample input corresponding to an item of the at least one of the set of similarity evidence items or the set of difference evidence items, a sample output;
determining a validation score based on a comparison between the expected output and the sample output; and
ranking the at least one of the set of similarity evidence items or the set of difference evidence items based on the validation score.

8. The computer-implemented method of claim 1, wherein generating the feedback comprises identifying, based on the reasoning explanation, at least one of a syntactic correction or a semantic correction.

9. The computer-implemented method of claim 1, wherein obtaining the feedback comprises:
generating a retrieval-augmented generation (RAG) prompt for the machine learning component; and
obtaining, from the machine learning component, the feedback based on the RAG prompt.

10. The computer-implemented method of claim 9, wherein generating the RAG prompt comprises:
identifying at least one error associated with the generated code;
identifying at least one potential solution associated with the at least one error; and
generating the RAG prompt based on information indicative of the at least one error and the at least one potential solution.

11. The computer-implemented method of claim 9, wherein generating the RAG prompt comprises:
generating the RAG prompt based on a sentiment associated with the RAG prompt.

12. The computer-implemented method of claim 1, wherein the action comprises a system administration operation or a shell script task.

13. A computer program product, comprising:
one or more computer-readable storage media; and
program instructions stored on the one or more computer-readable storage media to perform operations, comprising:
receiving an indication of an action to be performed by generated code, wherein the generated code is generated by a large language model (LLM);
determining, using a machine learning component, a functionality of the generated code;
determining, using the machine learning component, a functional correctness of the generated code by performing a semantic validation operation without executing the generated code or comparing the generated code to a ground truth reference;
extracting a reasoning explanation associated with the functional correctness of the generated code;
obtaining feedback based on the reasoning explanation; and
generating a refined prompt by refining a prompt using the generated feedback to improve subsequent code generation by the LLM.

14. The computer program product of claim 13, the operations further comprising:
decomposing the action into one or more atomic sub-actions prior to generating the code.

15. The computer program product of claim 14, the operations further comprising:
determining whether an atomic sub-action is automatable; and
generating the prompt based on determining that the atomic sub-action is automatable.

16. The computer program product of claim 14, the operations further comprising:
determining, based on the one or more atomic sub-actions, that the action is complete;
and generating the prompt based on determining that the action is complete.

17. The computer program product of claim 14, the operations further comprising:
determining, based on the one or more atomic sub-actions, that the action is incomplete; and
obtaining completion information from one or more systems based on determining that the action is incomplete.

18. A computer system, comprising:
a processor set;
one or more computer-readable storage media; and
program instructions stored on the one or more computer-readable storage media to cause the processor set to perform operations comprising:
receiving an indication of an action to be performed by generated code, wherein the generated code is generated by a large language model (LLM);
determining, using a machine learning component, a functionality of the generated code;
determining, using the machine learning component, a functional correctness of the generated code by performing a semantic validation operation without executing the generated code or comparing the generated code to a ground truth reference;
extracting a reasoning explanation associated with the functional correctness of the generated code;
obtaining feedback based on the reasoning explanation; and
generating a refined prompt by refining a prompt using the generated feedback to improve subsequent code generation by the LLM.

19. The computer system of claim 18, wherein the action comprises a system administration operation or a shell script task.

20. The computer system of claim 18, the operations further comprising:
generating updated code based on the refined prompt.
